(19) United States
(12) Patent Application Publication
(10) Pub. No.: US 2026/0281670 A1
(43) Pub. Date: Sep. 17, 2026

(54) METHOD AND SERVER FOR PROVIDING RESPONSE MESSAGE TO MESSAGE TRANSMISSION REQUEST

(71) Applicant: SK Planet Co., Ltd., Seongnam-si (KR)

(72) Inventor: Nam Hoon KIM, Suwon-si (KR)

(21) Appl. No.: 19/668,851

(22) Filed: May 6, 2026

Related U.S. Application Data
(63) Continuation of application No. PCT/KR2024/020888, filed on Dec. 20, 2024.

(30) Foreign Application Priority Data
Jan. 12, 2024 (KR) 10-2024-0005581
Feb. 21, 2024 (KR) 10-2024-0024942
Feb. 21, 2024 (KR) 10-2024-0024943

(51) Int. Cl. H04W 4/14; H04W 4/16; H04W 8/02; H04W 8/18

(52) U.S. Cl. CPC H04W 4/14; H04W 4/16; H04W 8/02; H04W 8/18

(57) ABSTRACT

Disclosed are a method including: receiving, by a telecommunications company server, from a transmission terminal, an outgoing call request for transmitting a plurality of voice messages to a reception terminal; determining, by the telecommunications company server, whether a receiver account corresponding to the reception terminal is subscribed to an overseas notification service upon receiving the outgoing call request; routing, by the telecommunications company server, a line connection between the reception terminal and the transmission terminal to pass through a service server when the receiver account is subscribed to the overseas notification service; providing, by the service server, a first response message corresponding to a first voice message, which is any one of the plurality of voice messages, to the transmission terminal; and providing a second response message corresponding to a second voice message.

### CROSS-REFERENCE TO RELATED APPLICATIONS

This is a bypass continuation of International PCT Application No. PCT/KR2024/020888, filed on Dec. 20, 2024, which claims priority to Republic of Korea Patent Application No. 10-2024-0005581, filed on Jan. 12, 2024, Republic of Korea Patent Application No. 10-2024-0024942, filed on Feb. 21, 2024, and Republic of Korea Patent Application No. 10-2024-0024943, filed on Feb. 21, 2024, which are incorporated by reference herein in their entirety.

### TECHNICAL FIELD

The technical field of the present disclosure relates to a system that supports a service that enables a message, which is requested to a reception terminal in the country, to be checked overseas, a method thereof, and a computer-readable recording medium on which a program for executing the method on a computer is recorded, and relates to a technical field that enables a response message corresponding to an outgoing call request requested from a transmission terminal to be provided to a reception terminal.

Further, the technical field of the present disclosure relates to a system that supports an identity authentication service that enables a message, which is requested to a reception terminal, to be checked, a method thereof, and a computer-readable recording medium on which a program for executing the method on a computer is recorded, and relates to a technical field that enables a service-related message to be provided to a reception terminal by performing identity authentication on a receiver account when a service provision request is received from the reception terminal.

### BACKGROUND ART

Generally, in the case of conventional international call services, communication services using telephones or wired/wireless communication have been mainly provided to customers through voice calls and text message services. In overseas countries, there were time differences between the countries, and thus even in international phone calls, there were many cases in which a message a transmitter wants to transmit is not transmitted on time or is transmitted briefly due to factors such as time differences, expensive rates, etc. Further, in the case of text messages, there was a disadvantage in that text messages had to be written in English or the like, because the types of terminals used and languages supported were different in each country, and in the case of overseas roaming phones, there was a disadvantage in that there were limitations in expressing messages when transmitting text messages in Korean to customers roaming abroad from Korea. Further, prepaid/postpaid card services, which are widely used when traveling abroad, only provide simple voice-based calls, that is, do not provide supplementary services for international calling services. In the case of roaming, although it is possible to make and receive calls with users’ own numbers in countries with which automatic roaming agreements have been concluded, roaming charges are expensive and may be a burden to the users, and there is a limitation that restrictions may occur due to different frequency bands depending on the country or region for which automatic roaming is targeted. Therefore, there is a need for a method and service that can overcome the above-described limitations of roaming.

Further, when a user travels abroad and wants to continue using a mobile terminal he or she used in the country without change, the user can use the mobile terminal he or she used in the country through roaming, but such a roaming method has a problem of being very expensive because the fee is charged per call time or data usage. Recently, a roaming fee system that charges a flat rate per day within a specified call time range or data usage range has been used, but such a roaming fee system does not cost much for a short-term stay of 2 to 3 days, but has a problem of charging excessively high fees for a medium-term stay of several weeks to several months. In order to partially solve these problems, there are cases in which pocket Wi-Fi or prepaid universal subscriber identity modules (USIMs) are purchased and used in foreign countries. However, these pocket Wi-Fi or prepaid USIMs only provide a flat rate for a specified amount of data for a specified period of time, but there is a problem that expensive roaming charges are incurred when using phone calls or wireless messages (e.g., Short Message Service (SMS), Enhanced Messaging Service (EMS), Multimedia Messaging Service (MMS), etc.) that pass through exchanges, and when a user purchases and uses a prepaid USIM in foreign countries, there is a problem that user identity authentication corresponding to the USIM used in the country may be uncertain. Therefore, there is a need for a method and service that can overcome the above-described limitations of using USIMs in foreign countries.

Further, depending on transmitters, unnecessary text and voice messages are often provided, inevitably resulting in delays in transmission times. Therefore, there is a need for a method and service that can overcome the above-described limitations of roaming.

### SUMMARY

The present disclosure is directed to providing a system that supports response messages corresponding to a plurality of messages received by a reception terminal in the country to be received in non-real time without using a roaming service overseas.

The present disclosure is also directed to providing a system that performs identity authentication for a receiver account corresponding to a reception terminal in order to enable response messages corresponding to a plurality of messages received by the reception terminal in the country to be received without using a roaming service overseas.

The present disclosure is also directed to providing a system that supports response messages to be received in real time or non-real time according to the characteristics of a transmitter account corresponding to a plurality of messages received by a reception terminal in the country without using a roaming service overseas.

Objects of the present disclosure are not limited to the above-described objects and other objects that are not described may be clearly understood by those skilled in the art from the following descriptions.

A first aspect of the present disclosure provides a method of providing a response message in response to a message transmission request, which includes: receiving, by a telecommunications company server, from a transmission terminal, an outgoing call request for transmitting a plurality of voice messages to a reception terminal; determining, by the telecommunications company server, whether a receiver account corresponding to the reception terminal is subscribed to an overseas notification service upon receiving the outgoing call request; routing, by the telecommunications company server, a line connection between the reception terminal and the transmission terminal to pass through a service server when the receiver account is subscribed to the overseas notification service; providing, by the service server, a first response message corresponding to a first voice message, which is any one of the plurality of voice messages, to the transmission terminal; and providing, by the service server, a second response message corresponding to a second voice message, which is any one of the plurality of voice messages, to the reception terminal.

Further, the method may further include determining, by the service server, each of the plurality of voice messages as the first voice message or the second voice message based on the results of analysis of the plurality of voice messages.

Further, the determining of each of the plurality of voice messages as the first voice message or the second voice message may further include: determining, by the service server, a level of need for transmission indicating the degree to which the plurality of voice messages need to be transmitted to the receiver account; and determining, by the service server, each of the plurality of voice messages as the first voice message or the second voice message according to the level of need for transmission.

Further, in determining whether the receiver account is subscribed to the overseas notification service, when a location of the reception terminal is determined to be overseas, the telecommunications company server may determine whether the receiver account is subscribed to the overseas notification service.

Further, in providing, by the service server, the first response message to the transmission terminal, the first response message may be provided to the transmission terminal using a domestic line, and in providing, by the service server, the second response message to the reception terminal, the second response message may be provided to the reception terminal using an overseas line.

Further, in the provision of the second response message to the reception terminal, the service server may provide the second response message to the reception terminal using an overseas public network.

Further, determining whether the receiver account is subscribed to the overseas notification service may further include: determining, by the telecommunications company server, whether the receiver account is subscribed to the overseas notification service based on a first universal subscriber identity module (USIM) for domestic use that is installed in the reception terminal when the location of the reception terminal is determined to be overseas, performing, by the service server, an identity authentication request on the reception terminal when the receiver account is subscribed to the overseas notification service; and requesting, by the service server, registration of at least one piece of overseas notification authentication information from the reception terminal when the identity authentication is completed.

Further, the method may further include performing, by the service server, authentication on the reception terminal based on the registered overseas notification authentication information when a second USIM for overseas use is installed in the reception terminal.

Further, the method may further include requesting, by the service server, installation of the first USIM from the reception terminal when a preset period of time has elapsed since the second USIM was installed.

A second aspect of the present disclosure provides a system for providing a response message in response to a message transmission request, which includes: a telecommunications company server configured to receive, from a transmission terminal, an outgoing call request for transmitting a plurality of voice messages to a reception terminal, determine whether a receiver account corresponding to the reception terminal is subscribed to an overseas notification service, upon receiving the outgoing call request, and route a line connection between the reception terminal and the transmission terminal to pass through a service server when the receiver account is subscribed to the overseas notification service; and the service server configured to provide a first response message corresponding to a first voice message, which is any one of the plurality of voice messages, to the transmission terminal and provide a second response message corresponding to a second voice message, which is any one of the plurality of voice messages, to the reception terminal.

Further, the service server may determine each of the plurality of voice messages as the first voice message or the second voice message based on results of analysis of the plurality of voice messages.

Further, the service server may determine a level of need for transmission indicating a degree to which the plurality of voice messages need to be transmitted to the receiver account, and determine each of the plurality of voice messages as the first response message or the second response message according to the level of need for transmission.

A third aspect of the present disclosure provides a non-transitory computer-readable recording medium on which a program for implementing the method of the first aspect is recorded.

A fourth aspect of the present disclosure provides a method of providing a service-related message as identity authentication is performed, which includes: receiving, by a service server, a service provision request for requesting provision of an overseas notification service from a receiver account corresponding to a reception terminal; determining, by the service server, whether the receiver account is subscribed to the overseas notification service upon receiving the service provision request; performing, by the service server, first identity authentication on the receiver account using an ID and a password when the receiver account is subscribed to the overseas notification service; performing, by the service server, second identity authentication on the receiver account using at least one of a pre-designated keyword, an access Internet Protocol (IP) band, location information, and an email address when the first identity authentication is performed normally; determining, by the service server, whether a timeout occurs based on a time count situation in which a count starts according to a type of universal subscriber identity module (USIM) inserted into the reception terminal when the second identity authentication is performed; and providing, by the service server, a message indicating that the overseas notification service is provided to the receiver account when the timeout does not occur.

Further, in determining whether the timeout occurs, when the USIM inserted into the reception terminal is an USIM for overseas use, the count may start.

Further, the method may further include performing, by the service server, identity re-authentication using a USIM for domestic use inserted into the reception terminal when the timeout occurs; and releasing, by the service server, the timeout upon performing the identity re-authentication.

Further, the method may further include: receiving, by the service server, a service subscription request for requesting subscription to the overseas notification service from the receiver account; obtaining, by the service server, registration information including at least one of an ID, a password, international mobile equipment identity (IMEI), connection information (CI), and biometric information upon receiving the service subscription request; and providing, by the service server, a message indicating that the receiver account is subscribed to the overseas notification service upon obtaining the registration information.

Further, the providing of the message indicating that the overseas notification service is provided may include: determining, by the service server, an identity authentication level based on the time count situation; and performing, by the service server, third identity authentication according to an additional authentication method corresponding to the identity authentication level.

Further, in the performing of the third identity authentication, when the identity authentication level is Level 1, identity authentication may be performed based on a pattern input that is input from the receiver account, when the identity authentication level is Level 2, identity authentication may be performed based on a fingerprint input that is input from the receiver account, when the identity authentication level is Level 3, identity authentication may be performed based on the pattern input and the fingerprint input that are input from the receiver account, and the identity authentication level may be higher in order of Level 3, Level 2, and Level 1.

Further, in the performing of the identity re-authentication, when the count starts based on the time count situation and a preset period of time has elapsed, the service server may request the identity re-authentication for the receiver account.

Further, the identity authentication level may be determined in proportion to an elapsed time at which the count starts and exceeds.

Further, in the determining of the identity authentication level, the identity authentication level may be determined further based on a difference between a first time point at which the first identity authentication is performed and a second time point at which the second identity authentication is performed.

Further, in determining whether the timeout occurs, the service server may update the preset period of time corresponding to the timeout based on a number of times of the first identity authentication and a number of times of the second identity authentication.

A fifth aspect of the present disclosure provides a server for providing a service-related message as identity authentication is performed, which includes: a reception unit configured to receive a service provision request for requesting provision of an overseas notification service from a receiver account corresponding to a reception terminal; and a processor that is configured to determine whether the receiver account is subscribed to the overseas notification service upon receiving the service provision request, perform first identity authentication on the receiver account using an ID and a password when the receiver account is subscribed to the overseas notification service, perform second identity authentication on the receiver account using at least one of a pre-designated keyword, an access Internet Protocol (IP) band, location information, and an email address when the first identity authentication is performed normally, determine whether a timeout occurs based on a time count situation in which a count starts according to a type of universal subscriber identity module (USIM) inserted into the reception terminal when the second identity authentication is performed, and provide a message indicating that the overseas notification service is provided to the receiver account when the timeout does not occur.

Further, the processor may start the count when the USIM inserted into the reception terminal is an USIM for overseas use, perform identity re-authentication using an USIM for domestic use inserted into the reception terminal when the timeout occurs, and release the timeout upon performing the identity re-authentication.

A sixth aspect of the present disclosure provides a non-transitory computer-readable recording medium on which a program for implementing the method of the fourth aspect is recorded.

A seventh aspect of the present disclosure provides a method of providing a response message according to transmitter account authentication, which includes: receiving, by a telecommunications company server, from a transmission terminal, an outgoing call request for transmitting a plurality of voice messages to a reception terminal; determining, by the telecommunications company server, whether a receiver account corresponding to the reception terminal is subscribed to an overseas notification service upon receiving the outgoing call request; routing, by the telecommunications company server, a line connection between the reception terminal and the transmission terminal to pass through a service server when the receiver account is subscribed to the overseas notification service; obtaining, by the service server, transmitter account characteristic information including at least one of a transmitter nationality, a transmitter communication network, and a transmitter phone number for a transmitter account corresponding to the transmission terminal; determining, by the service server, a call processing method including at least one of an additional notification type, a transmission priority, a type of network used for transmission, and a format of a message to be transmitted for the plurality of voice messages based on the transmitter account characteristic information; and providing, by the service server, response messages corresponding to the plurality of voice messages to the reception terminal based on the call processing method.

Further, in the determination of the call processing method, the service server may determine the call processing method based on whether the transmitter phone number is a number pre-stored in the reception terminal.

Further, the determination of the call processing method may include: determining, by the service server, a transmission importance level based on the transmitter account characteristic information and results of analysis of the plurality of voice messages; and determining, by the service server, the additional notification type, the transmission priority, the type of network used for transmission, and the format of the message based on the transmission importance level.

Further, when the transmission importance level is higher than or equal to Level 1, the service server may provide the response messages to the reception terminal through a dedicated network, and when the transmission importance level is lower than Level 1, the service server may provide the response messages to the reception terminal through a public network.

Further, the additional notification type may include at least one of an emergency notification message, a voice file message, and an emergency transmitter notification message, and the format of the message may include at least one of a summary format, a text format, and a link processing format.

Further, the determination of the transmission importance level may include: determining, by the service server, a transmitter priority based on whether the transmitter phone number is a number pre-stored in the reception terminal, a preset number from the reception terminal, and a spam number; determining, by the service server, a message priority based on message content analysis results of the plurality of voice messages; and determining, by the service server, the transmission importance level based on the transmitter priority and the message priority, and a weight higher than that of the message priority may be assigned to the transmitter priority.

Further, in the determination of the transmission importance level, the service server may determine the transmission importance level based on weights assigned so as to be gradually lowered in order of the preset number, the pre-stored number, and the message content analysis result, and the service server may provide a risk notification message based on weights assigned so as to be gradually lowered in order of the transmitter communication network, the transmitter nationality, and the message content analysis results when the transmitter phone number is the spam number or is not the pre-stored number.

Further, when the transmission importance level is higher than or equal to Level 1 and is lower than Level 2, which is higher than Level 1, the service server may sequentially provide the response messages to the reception terminal through the dedicated network, and when the transmission importance level is higher than or equal to Level 2, the service server may provide the response messages to the reception terminal according to the transmission priority together with the additional notification type.

Further, in determining whether the receiver account is subscribed to the overseas notification service, when a location of the reception terminal is determined to be overseas, the telecommunications company server may determine whether the receiver account is subscribed to the overseas notification service.

An eighth aspect of the present disclosure provides a system for providing a response message according to transmitter account authentication, which includes: a telecommunications company server that is configured to receive, from a transmission terminal, an outgoing call request for transmitting a plurality of voice messages to a reception terminal, determine whether a receiver account corresponding to the reception terminal is subscribed to the overseas notification service upon receiving the outgoing call request, and route a line connection between the reception terminal and the transmission terminal to pass through a service server when the receiver account is subscribed to the overseas notification service; and the service server that is configured to obtain transmitter account characteristic information including at least one of a transmitter nationality, a transmitter communication network, and a transmitter phone number for a transmitter account corresponding to the transmission terminal, determine a call processing method including at least one of an additional notification type, a transmission priority, a type of network used for transmission, and a format of a message to be transmitted for the plurality of voice messages based on the transmitter account characteristic information, and provide response messages corresponding to the plurality of voice messages to the reception terminal based on the call processing method.

Further, the service server may determine the call processing method based on whether the transmitter phone number is a number pre-stored in the reception terminal.

Further, the service server may determine a transmission importance level based on the transmitter account characteristic information and results of analysis of the plurality of voice messages and determine the additional notification type, the transmission priority, the type of network used for transmission, and the format of the message based on the transmission importance level.

A ninth aspect of the present disclosure provides a non-transitory computer-readable recording medium on which a program for implementing the method of the seventh aspect is recorded.

According to an embodiment of the present disclosure, user satisfaction can be improved by reducing the burden of large roaming charges that may arise during long-term stays abroad.

Further, the efficiency of response message provision can be improved by determining a first voice message and a second voice message based on a level of need for transmission and providing different response messages to a transmission terminal and a reception terminal.

Further, since a user uses a first universal subscriber identity module (USIM) and a second USIM of different countries and authentication is further performed using overseas notification authentication information, security can be improved by providing a response message to a reception terminal when authentication is completed.

Further, when providing an overseas notification service, security can be improved by performing first identity authentication and second identity authentication.

Further, security can be further secured by performing identity re-authentication based on a time count situation.

Further, both user convenience and security can be secured by further performing third identity authentication for each level of difficulty according to the additional authentication method corresponding to an identity authentication level.

Further, the efficiency of response message provision can be improved by identifying outgoing call requests received from unnecessary transmitter accounts and providing response messages.

Further, the satisfaction of users receiving response messages can be improved by providing voice messages with different call processing methods applied according to transmitter account characteristic information.

Effects of the present disclosure are not limited to the above-described effects and other effects that are not described may be clearly understood by those skilled in the art from the following descriptions.

### BRIEF DESCRIPTION OF THE DRAWINGS

FIG. 1 is a block diagram schematically illustrating a configuration of a system for providing a response message in response to a message transmission request according to a first embodiment of the present disclosure.

FIG. 2 is a flowchart schematically illustrating the respective operations of providing a response message to a transmission terminal or a reception terminal in the system for providing the response message in response to the message transmission request according to the first embodiment of the present disclosure.

FIG. 3 is a flowchart schematically illustrating the respective operations of providing a response message to a reception terminal as a telecommunications company server routes a line connection to pass through a service server according to the first embodiment of the present disclosure.

FIG. 4 is a diagram illustrating an example in which a server provides corresponding response messages in response to an outgoing call request for transmitting a plurality of voice messages according to the first embodiment of the present disclosure.

FIG. 5 is a diagram illustrating an example in which the server provides corresponding response messages in response to an outgoing call request for transmitting a plurality of text messages according to the first embodiment of the present disclosure.

FIG. 6 is a flowchart schematically illustrating the respective operations according to an example in which the server performs an identity authentication process in order to support an overseas notification service according to the first embodiment of the present disclosure.

FIG. 7 is a flowchart schematically illustrating the respective operations according to an example in which the server performs an identity authentication re-request process when a preset period of time has passed since the identity authentication process is performed according to the first embodiment of the present disclosure.

FIG. 8 is a flowchart schematically illustrating the respective operations of providing, by the server, a first response message and a second response message based on a level of need for transmission according to the first embodiment of the present disclosure.

FIG. 9 is a flowchart schematically illustrating the respective operations according to an example in which the server processes a plurality of voice messages and provides response messages according to the first embodiment of the present disclosure.

FIG. 10 is a flowchart schematically illustrating the respective operations according to an example in which the server processes a plurality of text messages and provides response messages according to the first embodiment of the present disclosure.

FIG. 11 is a block diagram schematically illustrating a configuration of a system for providing a service-related message as identity authentication is performed according to a second embodiment of the present disclosure.

FIG. 12 is a flowchart schematically illustrating the respective operations of providing a message indicating that an overseas notification service for a receiver account is provided in the system for providing the service-related message as the identity authentication is performed according to the second embodiment of the present disclosure.

FIG. 13 is a flowchart schematically illustrating the respective operations of determining whether a receiver account is subscribed to an overseas notification service as a service server receives a service subscription request from a reception terminal according to the second embodiment of the present disclosure.

FIG. 14 is a flowchart schematically illustrating respective operations of requesting, by the service server, identity re-authentication from the reception terminal according to the second embodiment of the present disclosure.

FIG. 15 is a flowchart schematically illustrating an example in which the service server performs identity re-authentication on a receiver account corresponding to the reception terminal according to the second embodiment of the present disclosure.

FIG. 16 is a flowchart schematically illustrating an example in which the service server performs third identity authentication on the receiver account corresponding to the reception terminal according to the second embodiment of the present disclosure.

FIG. 17 is a flowchart illustrating the overall flow of the service server that performs an identity authentication process and a service-related message provision process according to the second embodiment of the present disclosure.

FIG. 18 is a block diagram schematically illustrating a configuration of a system for providing a response message according to transmitter account authentication according to a third embodiment of the present disclosure.

FIG. 19 is a flowchart schematically illustrating the respective operations of providing a response message to a reception terminal in the system for providing the response message according to transmitter account authentication according to the third embodiment of the present disclosure.

FIG. 20 is a flowchart schematically illustrating respective operations of providing the response message to the reception terminal as a telecommunications company server routes a line connection to pass through a service server according to the third embodiment of the present disclosure.

FIG. 21 is a flowchart schematically illustrating respective operations of determining, by a server, a transmission importance level according to the third embodiment of the present disclosure.

FIG. 22 is a flowchart schematically illustrating respective operations of providing, by the server, the response message to the reception terminal based on the transmission importance level according to the third embodiment of the present disclosure.

FIG. 23 is a flowchart schematically illustrating respective operations of performing, by the server, a specific process that determines the transmission importance level according to the third embodiment of the present disclosure.

FIG. 24 is a diagram schematically illustrating examples of some of various additional notification types and message formats of the response message according to the third embodiment of the present disclosure.

### DETAILED DESCRIPTION

Advantages and features of the present disclosure and methods of achieving the same will be clearly understood with reference to the accompanying drawings and embodiments described in detail below. However, the present disclosure is not limited to the embodiments to be disclosed below but may be implemented in various different forms. The embodiments are provided in order to make the present embodiments complete and fully inform those skilled in the art of the scope of the present disclosure.

Terms used herein are provided only to describe the embodiments of the present disclosure and not for purposes of limitation. In this specification, the singular forms include the plural forms unless the context clearly indicates otherwise. It will be understood that terms “comprise” and/or “comprising” used herein specify some stated components, but do not preclude the presence or addition of one or more other components. Like reference numerals throughout the specification denote like components, and “and/or” includes each and every combination of one or more of the above-described components. It should be understood that, although the terms “first,” “second,” etc. may be used herein to describe various components, these components are not limited by these terms. The terms are only used to distinguish one component from another component. Therefore, it should be understood that a first component to be described below may be a second component within the technical scope of the present disclosure.

Unless otherwise defined, all terms including technical and scientific terms used herein have the same meaning as commonly understood by those skilled in the art. Further, it should be further understood that terms, such as those defined in commonly used dictionaries, should not be interpreted in an idealized or overly formal sense unless expressly so defined herein.

Spatially relative terms “below,” “beneath,” “lower,” “above,” “upper,” etc., may be used to facilitate the description of a relationship between one component and other components as illustrated in the accompanying drawings. The spatially relative terms should be understood to include different directions of the element during use or operation in addition to the direction illustrated in the accompanying drawings. For example, when a component illustrated in the drawing are flipped, a component described as “below” or “beneath” another component may end up being placed “above” the other component. Therefore, an exemplary term “below” may include both downward and upward directions. Components may be arranged in different directions so that spatially relative terms may be interpreted according to the arrangement.

Prior to the description of this specification, the present disclosure may support obtaining a voice message and a response message for a message when transmitting a message by routing a service server on behalf of a reception terminal when a call connection attempt is made between a transmission terminal and the reception terminal in response to a message transmission outgoing call request for any one of a transmission terminal corresponding to another user to whom the user’s message is to be transmitted (used by another user to transmit a message to the user) and a user terminal (receiving terminal) of the user. In addition, an app server that supports a message transmission app service may be controlled by being linked with an app client, so that when information about a voice message or text message obtained in response to an outgoing call request is to be provided to the user terminal, a voice file, a text file, etc. may be provided to the user terminal. Regarding a system for providing a response message and a support service according to such message transmission, a process of processing voice messages and/or text messages between a service server, a telecommunications company server, and an app client in the process in which the system for providing the response message provides a response message in response to an outgoing call request received from a transmission terminal will be described with reference to the accompanying drawings.

The telecommunications company server is linked with the service server and app client using wired/wireless communication methods to enable mobile communication. Further, the telecommunications company server may support a message transmission service for a reception terminal or a transmission terminal. Here, the reception terminal may be a terminal corresponding to an account previously subscribed to an overseas notification supplementary service supported by the telecommunications company server. Further, when receiving an outgoing call request from the transmission terminal, the telecommunications company server may route a line connection through the service server, and thus message transmission may be supported through the service server. The service server receives a plurality of voice messages or a plurality of text messages from a transmitter (or user) and a receiver (or user) and obtains response messages for the received messages. In this case, here, a voice and text recognition function and a voice and text reception function may be performed using various known technologies.

The present disclosure may further include devices necessary for storing voice message content and/or text message content received through a mobile communication network in a storage memory, and since these devices are already known technologies, the devices will be easily understood by those skilled in the art even without being described in detail herein.

Hereinafter, embodiments of the present disclosure will be described in detail with reference to the accompanying drawings.

A server according to an embodiment described in the embodiments may be used to provide or perform various message transmission related services by being connected to a plurality of user terminals.

### First embodiment

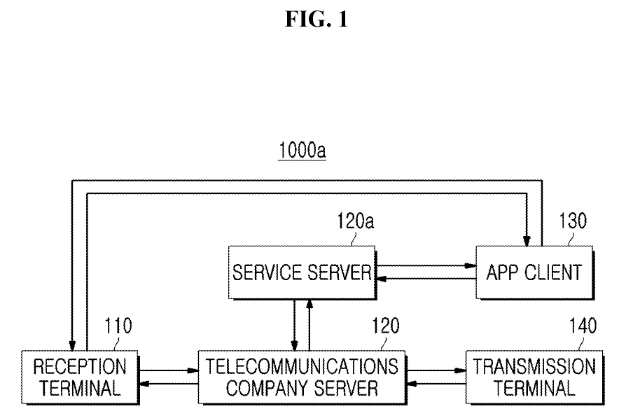

FIG. 1 is a block diagram schematically illustrating a configuration of a system 1000a for providing a response message in response to a message transmission request according to a first embodiment of the present disclosure.

Referring to the drawing, the system 1000a for providing the response message in response to the message transmission request may include a telecommunications company server 120 and a service server 120a. In an embodiment, the telecommunications company server 120 and the service server 120a may be performed on the same server through inter-server linkage, but are differently indicated as the telecommunications company server 120 or the service server 120a according to a subject on which various operations are performed. In an embodiment, the telecommunications company server 120 may receive, from a transmission terminal 140, an outgoing call request for transmitting a plurality of voice messages to a reception terminal 110. Further, upon receiving the outgoing call request, the telecommunications company server 120 may determine whether a receiver account corresponding to the reception terminal 110 is subscribed to an overseas notification service. Further, when the receiver account is subscribed to the overseas notification service, the telecommunications company server 120 may route a line connection between the reception terminal 110 and the transmission terminal 140 to pass through the service server 120a.

The service server 120a according to an embodiment may provide a first response message corresponding to a first voice message, which is any one of the plurality of voice messages, to the transmission terminal 140. Further, the service server 120a may provide a second response message corresponding to a second voice message, which is any one of the plurality of voice messages, to the reception terminal 110.

In an embodiment, the service server 120a may transmit the second response message to an app client 130 of the reception terminal 110. The app client 130 may be a device that supports an app service to the reception terminal 110. Therefore, the second response message may be provided to the receiver account through the app client 130. In an embodiment, when a message transmission request is obtained between the reception terminal 110 and the transmission terminal 140, the telecommunications company server 120, the service server 120a, and the app client 130 may be operated in conjunction with each other, and thus response message processing may be performed on the plurality of voice messages. The app client 130 may support an app service, which can store or generate a response message in response to the message transmission request, to the reception terminal 110, and receive various information from an app server within the service server 120a. That is, the server according to an embodiment may be operated by including the service server 120a, the telecommunications company server 120, and the app client 130.

Further, in the process in which the telecommunications company server 120 in the system 1000a for providing the response message in response to the message transmission request receives the outgoing call request, determines whether the receiver account is subscribed to the overseas notification service, and transmits the response message in response to the message transmission request to the app client 130 through the service server 120a, it should be noted that the components of the system 1000a may be combined by a combination of various conventional networks such as the Internet, mobile communication networks, mobile communication exchange servers, etc., and there are no specific restrictions on this.

In addition, it will be understood by those skilled in the art that other general components other than those illustrated in FIG. 1 may be further included in the system 1000a for providing the response message in response to the message transmission request. For example, the system 1000a for providing the response message in response to the message transmission request may further include a telecommunications company server 120 corresponding to the reception terminal 110, a supplementary service server that checks whether the receiver account is subscribed to the overseas notification service, a media server that obtains voice signals and processes media information when a call is connected, a web server that obtains and stores voice files, text files, etc. obtained through the voice signals, or the like. Alternatively, according to another embodiment, it will be understood by those skilled in the art that some of the components illustrated in FIG. 1 may be omitted.

Here, the telecommunications company server 120 is connected to communicate with an arbitrary internal component or at least one arbitrary external terminal via a wired/wireless communication network. In this case, the arbitrary external terminal may include the service server 120a, the app client 130, the reception terminal 110, etc. Here, wireless Internet technologies may include a wireless local area network (WLAN), Digital Living Network Alliance (DLNA), a wireless broadband (WiBro), Worldwide Interoperability for Microwave Access (WiMAX), High Speed Downlink Packet Access (HSDPA), High-Speed Uplink Packet Access (HSUPA), Institute of Electrical and Electronics Engineers (IEEE) 802.16, long-term evolution (LTE), LTE-Advanced (LTE-A), a wireless mobile broadband service (WMBS), fifth generation (5G) mobile communication service, Bluetooth, Radio-frequency identification (RFID), infrared data association (IrDA), ultra-wideband (UWB), Zigbee, near-field communication (NFC), ultra sound communication (USC), visible light communication (VLC), Wi-Fi, Wi-Fi Direct, long range (LoRa), etc., and the telecommunications company server 120 transmits or receives data according to at least one wireless Internet technology, including Internet technologies not listed above. Further, wired communication technologies may include power-line communication (PLC), Universal Serial Bus (USB) communication, Ethernet, serial communication, optical/coaxial cables, etc. Further, a communication unit may transmit or receive information to or from an arbitrary terminal through the USB. Further, the telecommunications company server 120 transmits or receives wireless signals to or from a base station, a response message providing server, the service server 120a, the app client 130, the reception terminal 110, etc. on a mobile communication network constructed according to technical standards or communication methods for mobile communication (e.g., Global System for Mobile communication (GSM), Code Division Multi Access (CDMA), Code Division Multi Access 2000 (CDMA2000), Enhanced Voice-Data Optimized or Enhanced Voice-Data Only (EVDO), Wideband CDMA (WCDMA), High Speed Downlink Packet Access (HSDPA), High Speed Uplink Packet Access (HSUPA), Long-Term Evolution (LTE), LTE-Advanced (LTE-A), etc.).

The system 1000a for providing the response message in response to the message transmission request according to an embodiment may be used when a plurality of transmission terminals 140 request message transmission to the reception terminal 110, may be linked with any type of handheld-based wireless communication device equipped with a touch screen panel, such as a mobile phone, a smartphone, a personal digital assistant (PDA), a portable multimedia player (PMP), a tablet personal computer (PC), etc., and in addition, may be used for message transmission through a system that includes or is linked with a device that has a foundation for installing and executing an application, such as a desktop PC, a tablet PC, a laptop PC, or an Internet Protocol television (IPTV) including a set-top box.

The system 1000a for providing the response message in response to the message transmission request may be implemented as a server, such as a computer or the like, that operates through a computer program to realize the functions described in this specification.

The system 1000a for providing the response message in response to the message transmission request according to an embodiment may include a message transmission related server (not illustrated), but the present disclosure is not limited thereto. The server according to an embodiment may support an application that provides a message transmission service.

Hereinafter, the description will focus on an embodiment in which the server that operates in the system 1000a for providing the response message in response to the message transmission request according to an embodiment independently provides the response message, but as described above, the server may be performed through linkage with a plurality of servers included in the system 1000a for providing the response message in response to the message transmission request. That is, it can be seen that the plurality of servers included in the system 1000a for providing the response message in response to the message transmission request according to an embodiment may be implemented in an integrated manner in terms of their functions, or may be omitted, and the present disclosure is not limited to any one embodiment.

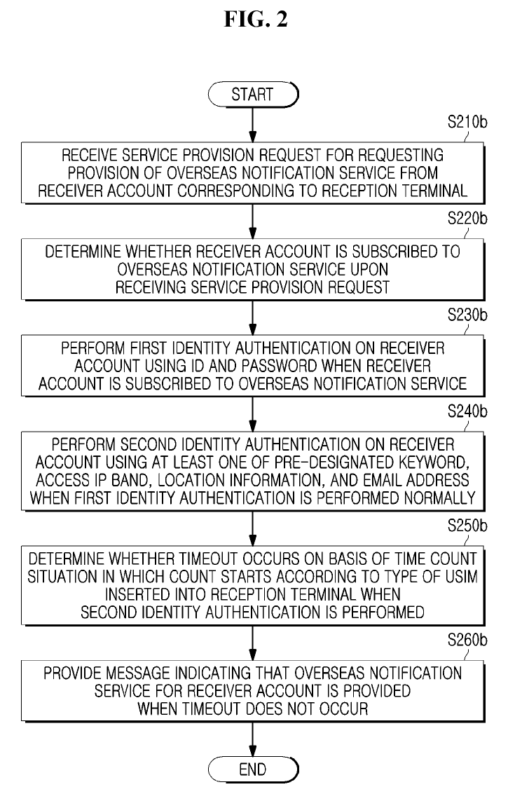

FIG. 2 is a flowchart schematically illustrating respective operations of providing a response message to the transmission terminal 140 or the reception terminal 110 in the system 1000a for providing the response message in response to the message transmission request according to the first embodiment of the present disclosure.

Referring to operation S210a, the telecommunications company server 120 according to an embodiment may receive, from the transmission terminal 140, an outgoing call request for transmitting a plurality of voice messages to the reception terminal 110. In an embodiment, the plurality of voice messages may include voice signals according to call connections. The telecommunications company server 120 may include a telecommunications company server 120 corresponding to a receiver account and a telecommunications company server 120 corresponding to a transmitter account and support call connections corresponding to the plurality of voice messages by making mobile communications through one or more telecommunications company servers 120. Therefore, the telecommunications company server 120 may receive, from the transmission terminal 140, the outgoing call request requested to the reception terminal 110. In an embodiment, an example in which the outgoing call request for transmitting the plurality of voice messages is received by the reception terminal 110 is illustrated as an embodiment, but the present disclosure is not limited thereto and may further include an example in which an outgoing call request for transmitting a plurality of text messages is received in addition to the plurality of voice messages.

Referring to operation S220a, the telecommunications company server 120 according to an embodiment may determine whether a receiver account corresponding to the reception terminal 110 is subscribed to an overseas notification service upon receiving the outgoing call request. In an embodiment, the overseas notification service may include a service that allows the receiver account overseas to receive response messages corresponding to the plurality of voice messages in response to at least one outgoing call request that is requested from the transmission terminal 140 in the country or to the reception terminal 110 corresponding to the receiver account in the country when the reception terminal 110 is located overseas. This may be an example of providing a response message in response to at least one outgoing call request received by the reception terminal 110 corresponding to the receiver account in the country to the reception terminal 110 overseas, for the receiver account that uses the telecommunications company server corresponding to the server according to an embodiment. In an embodiment, the telecommunications company server 120 may determine whether the receiver account is subscribed to the overseas notification service when the location of the reception terminal 110 is determined to be overseas. For example, the telecommunications company server 120 may check whether the receiver account is subscribed to the overseas notification service based on the location of the reception terminal 110. That is, the telecommunications company server 120 and the service server 120a do not support the overseas notification service when the location of the reception terminal 110 is domestic, and may support the overseas notification service when the location of the reception terminal 110 is overseas.

Referring to operation S230a, the telecommunications company server 120 according to an embodiment may route a line connection between the reception terminal 110 and the transmission terminal 140 to pass through the service server 120a when the receiver account is subscribed to the overseas notification service. When the receiver account is subscribed to the overseas notification service, the telecommunications company server 120 may be linked with the service server 120a to support the line connection and may support a notification service for the plurality of voice messages. In an embodiment, when the telecommunications company server 120 routes the line connection between the reception terminal 110 and the transmission terminal 140 to pass through the service server 120a according to whether the receiver account is subscribed the overseas notification service, the app client 130 may be further linked and operated through the service server 120a. For example, the service server 120a may further include an app server, and the app client 130 may be linked and operated by controlling the app server.

Referring to operation S240a, the service server 120a according to an embodiment may provide a first response message corresponding to a first voice message, which is any one of the plurality of voice messages, to the transmission terminal 140. In an embodiment, the first voice message may be a message deemed unlikely to be transmitted to the receiver account. Therefore, the service server 120a may provide the first response message indicating a response to the first voice message with a low need to be transmitted to the receiver account, to the transmission terminal 140.

Referring to operation S250a, the service server 120a according to an embodiment may provide a second response message corresponding to a second voice message, which is any one of the plurality of voice messages, to the reception terminal 110. In an embodiment, the second voice message may be a message that is determined highly necessary to be transmitted to the receiver account. Therefore, the service server 120a may perform voice processing on the second voice message that has a high need to be transmitted to the receiver account and provide the second response message obtained by performing voice processing to the reception terminal 110. In an embodiment, the service server 120a may determine each of the plurality of voice messages as the first voice message or the second voice message based on results of analysis of the plurality of voice messages. The first voice message may be a simple preset message such as “Hello,” and the first voice message and the second voice message may be classified based on artificial intelligence (AI)-based message content importance analysis. The service server 120a may determine a level of need for transmission indicating the degree to which the plurality of voice messages need to be transmitted to the receiver account. The service server 120a may determine each of the plurality of voice messages as the first voice message or the second voice message according to the level of need for transmission. In an embodiment, the service server 120a may determine the level of need for transmission based on word segments in the voice message. For example, when the number of word segments is two or fewer, the level of need for transmission may be determined as Level 1 with the lowest need for transmission. That is, the voice message containing two or fewer word segments, such as “Hello,” may correspond to Level 1. Further, when the number of word segments exceeds two and is less than or equal to a preset number (e.g., 10), the service server 120a may determine the level of need for transmission as Level 2, which is determined to have a higher need for transmission than Level 1, and when the number of word segments exceeds the preset number (e.g., 10), the service server 120a may determine the level of need for transmission as Level 3, which is determined to have a higher need for transmission than Level 2. Therefore, when a voice message determined to be at Level 1 is received, the service server 120a may provide the first response message requesting the purpose of a message transmission request to the reception terminal 110, to the transmission terminal 140. Further, when a voice message determined to be at Level 2 and/or Level 3 is received, the service server 120a may provide the second response message corresponding to the corresponding voice message, to the reception terminal 110. The second response message may be text data for the voice message or may be voice data. In another embodiment, when a voice message determined to be at Level 3 is received or when the number of plurality of response messages to be provided in non-real time is greater than equal to a preset number, the service server 120a may provide summarized text data as the second response message. For example, the service server 120a may obtain the summarized text data by performing a process of extracting main keywords based on independent morphemes. Therefore, when the number of response messages to be provided or the content of the response messages is greater than equal to a certain level, the response messages may be provided more efficiently by providing the summarized text data to the reception terminal 110. In another embodiment, the service server 120a may determine whether a voice file is transmitted based on preset transmitter information that has a high relationship with the receiver account, such as a family member, a friend, etc. For example, voice messages corresponding to transmitter information for advertising-purpose such as credit card companies or travel agencies may be more efficient in transmission using only text data, but voice messages corresponding to preset transmitter information such as family or friends may require more importance of voice data that can increase the efficiency of message transmission than text data, and thus in the case of the voice message corresponding to the preset transmitter information, voice data (voice files) may be provided to the reception terminal 110 preferentially compared to text data.

Therefore, the service server 120a may provide a first response message corresponding to at least one message determined as the first voice message to the transmission terminal 140 and provide a second response message corresponding to at least one message determined as the second voice message to the reception terminal 110. In an embodiment, the service server 120a may provide the first response message to the transmission terminal 140 using a domestic line. In an embodiment, the transmission terminal 140 may be a terminal that requests message transmission to a number corresponding to the reception terminal 110 in the country. Therefore, the service server 120a may provide the first response message using a domestic line. Further, the service server 120a may provide the second response message to the reception terminal 110 using an overseas line. The reception terminal 110 may be a terminal whose location changes from domestic to overseas. Therefore, the service server 120a may provide the second response message to the reception terminal 110 located overseas using an overseas line. In an embodiment, the overseas line may correspond to an overseas public network. That is, when an overseas network is connected using a network of a local telecommunications company where the reception terminal 110 is located, the second response message may be provided in non-real time.

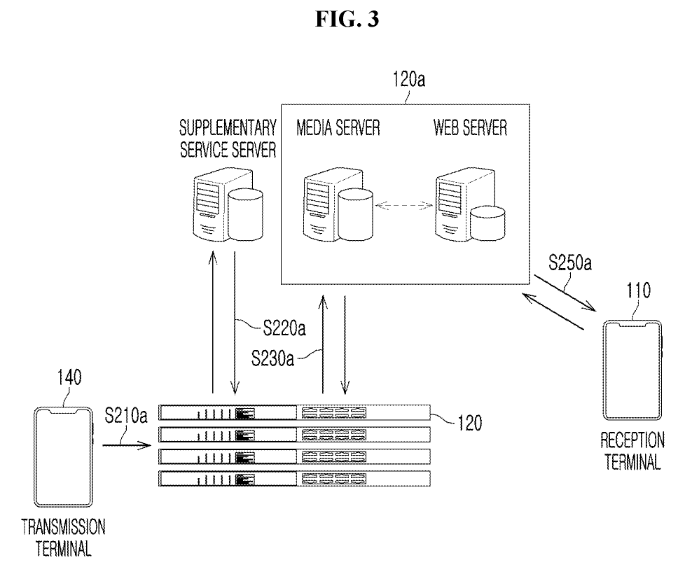

FIG. 3 is a flowchart schematically illustrating respective operations of providing a response message to the reception terminal 110 as the telecommunications company server 120 routes a line connection to pass through the service server 120a according to the first embodiment of the present disclosure.

Referring to FIG. 3, the service server 120a may include a media server and an app server. The media server may be a server that processes media information such as voice signals or voice messages, and the app server may be a server that is linked with the app client 130 that provides response messages. When an outgoing call request is received from the transmission terminal 140, the telecommunications company server 120 may determine whether the reception terminal 110, which is a target of message transmission, is subscribed to an overseas notification service. The telecommunications company server 120 may determine whether the receiver account is subscribed to the overseas notification service through a supplementary service server (S220a). Therefore, when the receiver account is subscribed to the overseas notification service, the telecommunications company server 120 may route a line connection between the transmission terminal 140 and the reception terminal 110 to pass through the service server 120a (S230a). The media server may provide a response message to the reception terminal 110 through the app server by communicating with the app server in a mobile communication method (S250a). In an embodiment, the app server may be a server that is linked with the app client 130, but provide a response message to the reception terminal 110 in non-real time according to the connection to an overseas line.

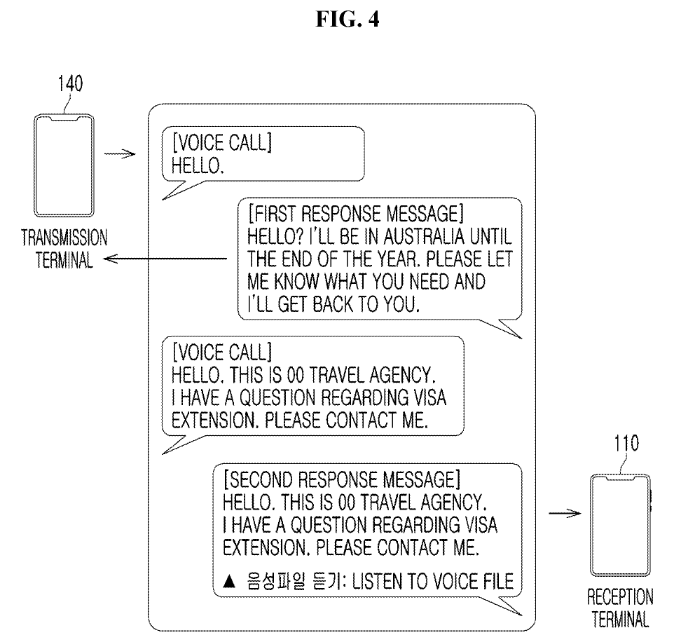

FIG. 4 is a diagram illustrating an example in which a server provides corresponding response messages in response to an outgoing call request for transmitting a plurality of voice messages according to the first embodiment of the present disclosure.

Referring to FIG. 4, the service server 120a according to an embodiment may determine a voice message corresponding to “Hello” among a plurality of voice messages received from the transmission terminal 140 as a first voice message and provide a first response message corresponding thereto to the transmission terminal 140. In an embodiment, the first response message may be a message corresponding to an automatic response service. For example, in order to re-receive a second voice message from the transmission terminal 140 that is determined to be a message with a high need for transmission to the receiver account when a message for which voice message transmission is requested is determined to be a message with a low need for transmission to the receiver account, the service server 120a may provide a first response message corresponding to a pre-stored automatic response signal or message to the transmission terminal 140. As illustrated in FIG. 4, when the first voice message is received by the reception terminal 110, the service server 120a may provide the first response message requesting the purpose of the first response message to the transmission terminal 140 in real time. Therefore, the service server 120a may perform AI-based voice recognition technology, speech-to-text (STT), on the second voice message re-received by the reception terminal 110 and provide the generated text as a second response message to the reception terminal 110. The second response message may be provided to the reception terminal 110 in non-real time using an overseas line. Further, the service server 120a may obtain a voice file for the second voice message and further provide the obtained voice file as the second response message.

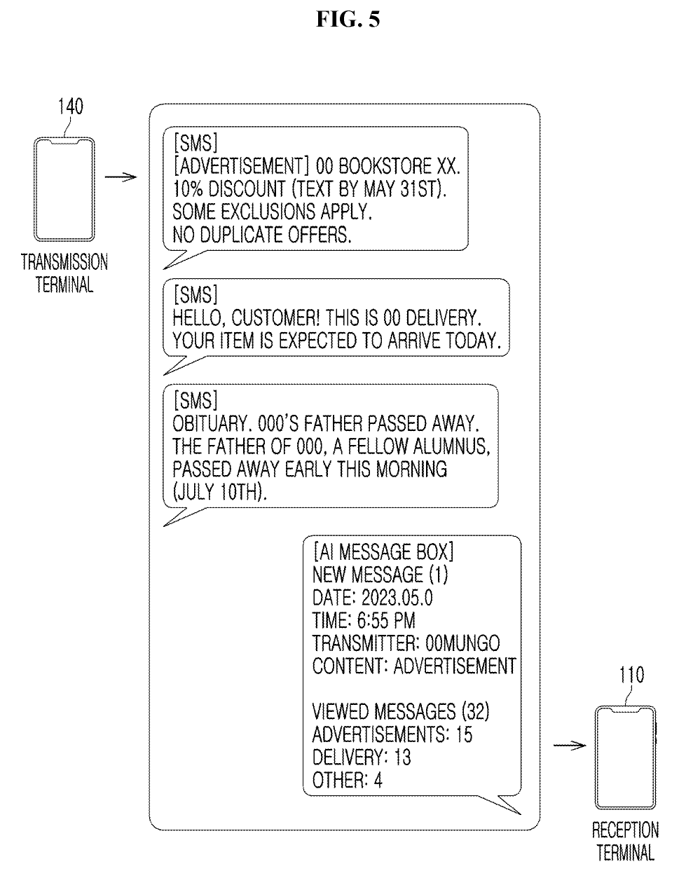

FIG. 5 is a diagram illustrating an example in which the server provides corresponding response messages in response to an outgoing call request for transmitting a plurality of text messages according to the first embodiment of the present disclosure.

Referring to FIG. 5, the service server 120a according to an embodiment may provide a response message to the reception terminal 110 in response to an outgoing call request for transmitting a plurality of Short Message Service (SMS) messages rather than a plurality of voice messages. For example, the service server 120a may support an AI message box service in which the plurality of SMS messages are classified through an app of the reception terminal 110. The service server 120a may analyze the content of each SMS message and provide information classified by a date received, a time received, transmitter information, and a category (content) for each message to the reception terminal 110. In FIG. 5, an example of providing an advertising message of OO Library to the reception terminal 110 is described, but in an embodiment, the service server 120a may determine a level of need for transmission based on the date received, the time received, the transmitter information, and the category (content) of each of the plurality of SMS messages, to determine whether notifications for response messages are transmitted and/or the order of transmission of notifications. Therefore, the response message may be provided to the reception terminal 110 in non-real time based on the determined order of transmission of notifications and whether the notifications are transmitted.

Further, in an embodiment, the service server 120a may determine a level of need for transmission for response messages corresponding to the plurality of voice messages or the plurality of SMS messages based on weights that are assigned to be gradually lowered in order of the transmitter information, the category (content), the date received, and the time received. For example, when a user corresponding to the receiver account stays abroad for a long period of time, the importance of a message requested for transmission from a transmitter corresponding to transmitter information that has a close relationship with the receiver account may be high, and thus the highest weight may be assigned to the transmitter information in determining the level of need for transmission. Further, the content of the message is an important factor in determining which messages have a high need for transmission because the content of the message is likely to include the main purpose of message transmission, and thus a second-highest weight may be assigned to the category (content). Further, when excluding the transmitter information and the category (content), the plurality of messages may be desirable to be sequentially provided in the order of being received, and thus a third- or fourth-highest weight may be assigned to the date received and the time received, respectively. Therefore, since the order of transmission of notifications is determined based on the level of need for transmission, the user corresponding to the receiver account may receive a message with high importance first. In another embodiment, the service server 120a may update the category (content) so that the highest weight is assigned to the category (content) in determining the level of need for transmission when the content of the message includes preset accident risk words (e.g., death, accident, obituary, father’s funeral, passing away, etc.). Therefore, it is possible to provide a response message corresponding to a message containing a word that is a risk of accident preferentially. In another embodiment, the service server 120a may update the category (content) so that the lowest weight is assigned to the category (content) in determining the level of need for transmission when the content of the message corresponds to an advertisement category (content). Therefore, the importance of the advertising message may be determined to be low, and a response message corresponding to the advertising message may be provided at a lower priority. Further, the service server 120a may determine not to transmit a notification of the message corresponding to the inventor information when the number of messages of the advertisement category (content) corresponding to the same inventor information is greater than or equal to a preset number. The above-described embodiments are not limited thereto and may be flexibly changed.

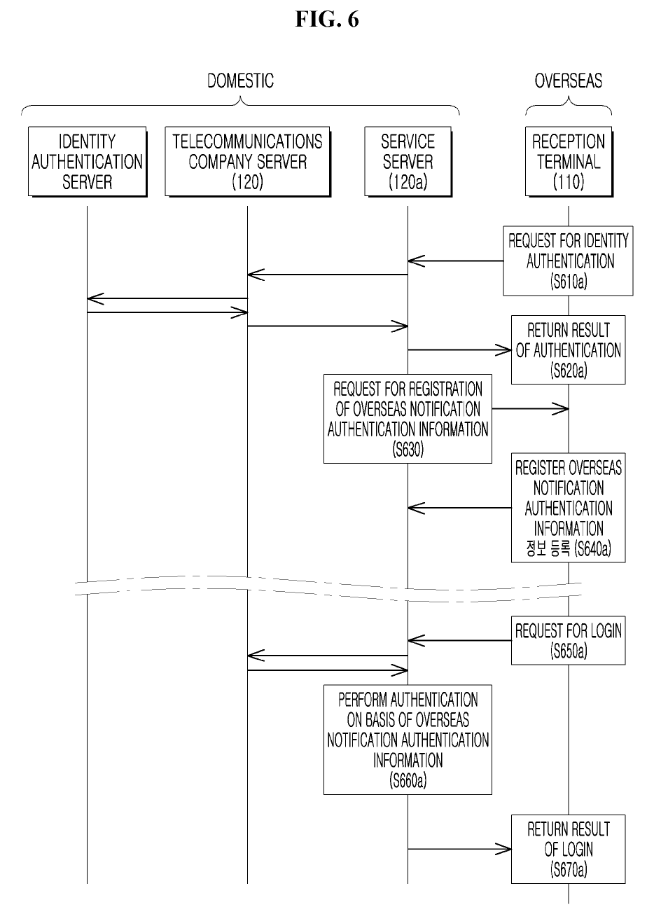

FIG. 6 is a flowchart schematically illustrating respective operations according to an example in which the server performs an identity authentication process in order to support an overseas notification service according to the first embodiment of the present disclosure.

Referring to FIG. 6, the service server 120a may receive an identity authentication request from the reception terminal 110 located overseas (S610a). As the service server 120a and the telecommunications company server 120 are linked, whether a receiver account corresponding to the reception terminal 110 is subscribed to an overseas notification service may be performed through an identity authentication server, and identity authentication may be performed using a preset password, unique identification number, etc. for the receiver account. Therefore, the service server 120a may return a result of the authentication to the reception terminal 110 (S620a). The telecommunications company server 120 may determine whether the receiver account is subscribed to the overseas notification service based on a universal subscriber identity module (USIM) installed in the reception terminal 110. For example, when the location of the reception terminal 110 is determined to be overseas, the telecommunications company server 120 may determine whether the receiver account is subscribed to the overseas notification service based on a first USIM for domestic use that is installed in the reception terminal 110. Further, when the receiver account is subscribed to the overseas notification service, the service server 120a may perform an identity authentication request on the reception terminal 110. When the identity authentication is completed, the service server 120a may request registration of at least one piece of overseas notification authentication information from the reception terminal 110. In an embodiment, the overseas notification authentication information may be authentication information for performing authentication on the receiver account of the reception terminal 110 overseas so that response messages for a plurality of voice messages or a plurality of text messages received at a number corresponding to the reception terminal 110 in the country may be provided through an app that supports provision of response messages even when the reception terminal 110 uses an overseas USIM. For example, the service server 120a may request registration of overseas authentication information from the reception terminal 110 so that the receiver account of the reception terminal 110 may register the overseas notification authentication information. The overseas notification authentication information may include a password, biometric information, a terminal’s unique identification number (international mobile equipment identity (IMEI)), connection information (CI), etc. In FIG. 6, operations S610a to S640a may be processes performed when the first USIM for domestic use is installed in the reception terminal 110. Further, operations following operation S650a may be processes performed when an USIM for overseas use is installed in the reception terminal 110. For example, a user corresponding to the receiver account may replace the USIM installed in the reception terminal 110 from the first USIM for domestic use to a second USIM for overseas use. The service server 120a may receive a login request through the app from the reception terminal 110 in which the second USIM for overseas use is installed (S650a). The service server 120a may perform authentication on the receiver account based on the overseas notification authentication information obtained from the reception terminal 110 when a login is requested (S660a). That is, when the second USIM for overseas use is installed on the reception terminal 110, the service server 120a may perform authentication on the receiver account of the reception terminal 110 based on the registered overseas notification authentication information. Therefore, the service server 120a may return a result of the login to the reception terminal 110 (S670a).

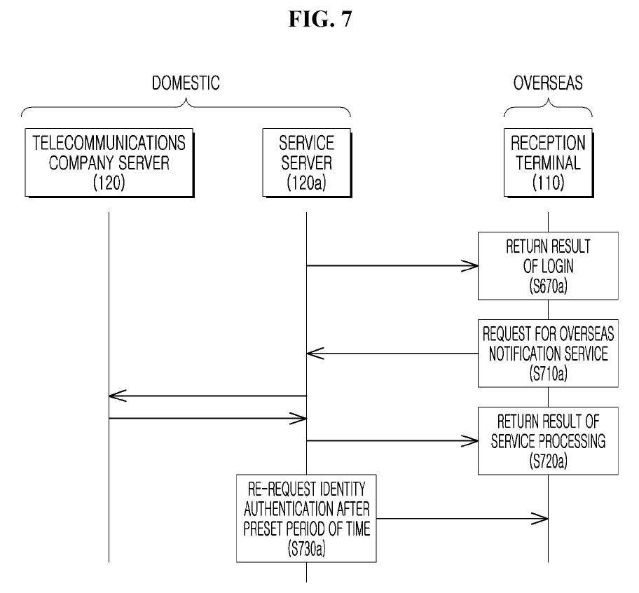

FIG. 7 is a flowchart schematically illustrating respective operations according to an example in which the server performs an identity authentication re-request process when a preset period of time has passed since the identity authentication process is performed according to the first embodiment of the present disclosure.

Referring to FIG. 7, the service server 120a according to an embodiment may receive an overseas notification service request from the reception terminal 110 (S710a). The overseas notification service request may be an example of a request made when a login to the receiver account is performed after a second USIM is installed in the reception terminal 110. That is, when entity authentication is performed overseas on the reception terminal 110 corresponding to the first USIM and a login request is received from the reception terminal 110 corresponding to the second USIM rather than the first USIM after overseas notification authentication information is registered, the overseas notification service request may be received by the service server 120a (S710a). Therefore, the service server 120a may return a result of service processing for the response message to the reception terminal 110 overseas by being linked with the telecommunications company server 120 (S720a). In an embodiment, the service server 120a may re-request identity authentication from the reception terminal 110 after a preset period of time (e.g., one month) (S730a). For example, when the preset period of time has elapsed since the second USIM is installed, the service server 120a may request installation of the first USIM in the reception terminal 110. The first USIM may be an element for performing identity authentication on the receiver account. Therefore, when the preset period of time has elapsed since the second USIM is installed, a notification requesting the re-installation of the first USIM may be provided to the reception terminal 110 in order to confirm the receiver account of the reception terminal 110 overseas for which response messages for a plurality of voice messages or plurality of text messages received at a number corresponding to the reception terminal 110 in the country are provided. When the first USIM is re-installed in the reception terminal 110, the service server 120a may re-perform identity authentication on the receiver account. In another embodiment, the service server 120a may update the preset period of time based on the number of plurality of voice messages and/or plurality of text messages received by the reception terminal 110. For example, an initial preset period of time may be applied equally as the preset period of time and the process may be performed, when the number of plurality of voice messages and/or plurality of text messages within the preset period of time is a first preset number, the preset period of time may be maintained, and when the number corresponds to a second number exceeding 150 percent of the first number, the preset period of time may be reduced to a period of time corresponding to 80 percent. Further, when the number of plurality of voice messages and/or plurality of text messages received within the preset period of time corresponds to a third number that is less than 50 percent of the first number, the preset period of time may be increased to a period of time corresponding to 150 percent. Therefore, security can be improved by adjusting the period of time required to re-perform the identity authentication based on the number of messages received.

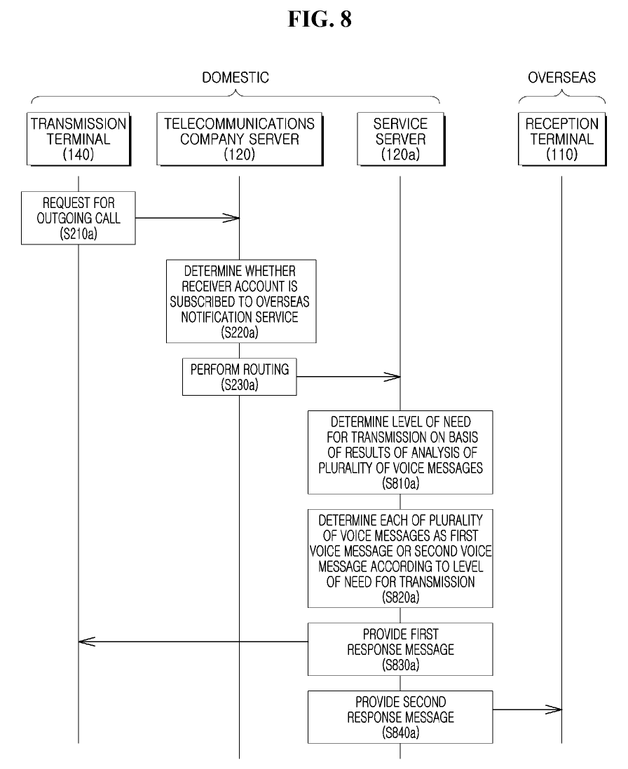

FIG. 8 is a flowchart schematically illustrating respective operations of providing, by the server, a first response message and a second response message based on a level of need for transmission according to the first embodiment of the present disclosure.

Referring to FIG. 8, the telecommunications company server 120 may receive an outgoing call request to the reception terminal 110 from the transmission terminal 140 (S210a). Therefore, the telecommunications company server 120 may determine whether a receiver account corresponding to the reception terminal 110 is subscribed to an overseas notification service (S220a). Further, when the receiver account is subscribed to the overseas notification service, the telecommunications company server 120 may route a line connection between the reception terminal 110 and the transmission terminal 140 to pass through the service server 120a (S230a). The service server 120a may determine a level of need for transmission for each message based on results of analysis of a plurality of voice messages in response to a message transmission request from the transmission terminal 140 (S810a). Further, as described in operation S250a, the service server 120a may determine each of the plurality of voice messages as a first voice message or a second voice message according to the level of need for transmission (S820a). Therefore, the service server 120a may provide a first response message corresponding to the first voice message to the transmission terminal 140 (S830a) and provide a second response message corresponding to the second voice message to the reception terminal 110 (S840a).

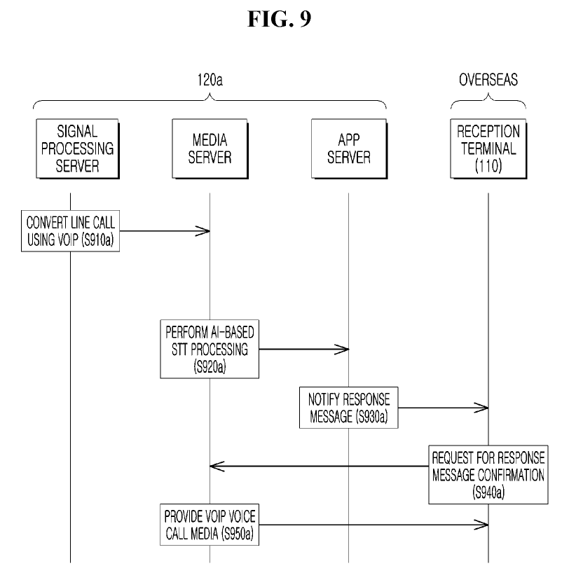

FIG. 9 is a flowchart schematically illustrating respective operations according to an example in which the server processes a plurality of voice messages and provides response messages according to the first embodiment of the present disclosure.

In an embodiment, the telecommunications company server 120 may obtain the location of a receiver account and information about whether the receiver account is subscribed to an overseas notification service by controlling a home location register (HLR) and/or visitor location register (VLR) of a mobile communication exchange, including a mobile communication exchange server. Further, the telecommunications company server 120 may obtain an incoming call server for an overseas notification service applicable area for the receiver account and route a line connection to the service server 120a.

Referring to FIG. 9, the service server 120a may include a signal processing server, a media server, and an app server. When the telecommunications company server 120 receives an outgoing call request for voice messages to the reception terminal 110 from the transmission terminal 140 and routes the line connection to pass through the service server 120a, the signal processing server of the service server 120a may convert the line connection using voice over Internet protocol (VoIP) (S910a). Therefore, the media server may convert the voice messages into text data by performing AI-based STT processing on the plurality of voice messages converted using VoIP (S920a). The app server may provide a response message notification through an app installed on the reception terminal 110 (S930a). For example, the response message notification may be a notification indicating that a plurality of response messages to be transmitted corresponding to the plurality of voice messages are present. In an embodiment, the response message notification provided in non-real time to the reception terminal 110 overseas may be a notification for a single response message or may be a notification for a plurality of accumulated response messages. The media server may receive a response message confirmation request from the reception terminal 110 through the app (S940a). Therefore, the media server may provide VoIP voice call media, on which STT processing is performed, to the reception terminal 110 (S950a). In an embodiment, the voice call media may be a second response message corresponding to the voice message provided to the reception terminal 110 and may include a plurality of response messages corresponding to the plurality of voice messages.

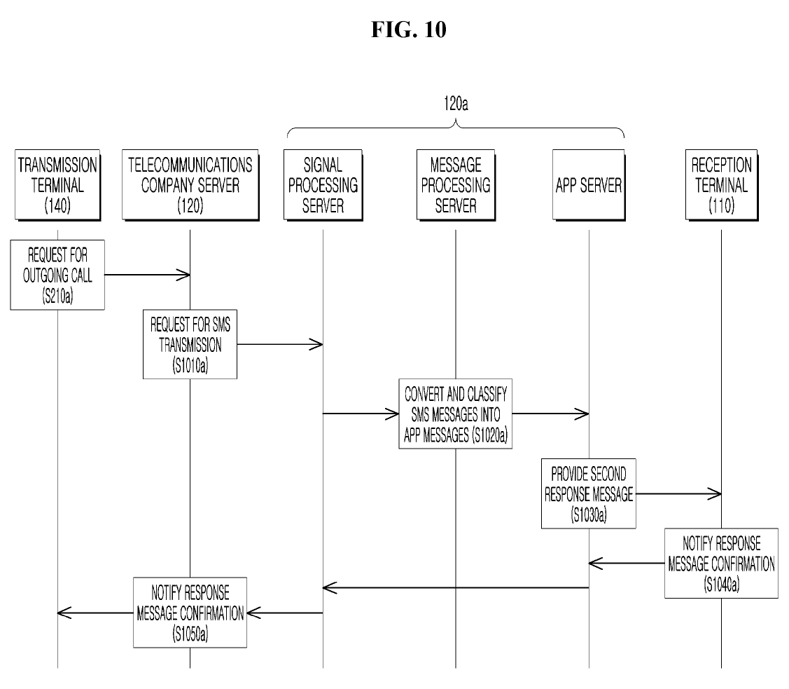

FIG. 10 is a flowchart schematically illustrating respective operations according to an example in which the server processes a plurality of text messages and provides response messages according to the first embodiment of the present disclosure.

As described above, the telecommunications company server 120 may obtain information about whether the receiver account is subscribed to an overseas notification service. Further, the telecommunications company server 120 may obtain an incoming call number for an overseas notification service applicable area for the receiver account, store it in the SMS server, and route a line connection to the service server 120a.

Referring to FIG. 10, when the telecommunications company server 120 receives an outgoing call request for a text message to the reception terminal 110 from the transmission terminal 140, the telecommunications company server 120 may route a line connection to pass through the service server 120a and transmit an SMS transmission request to the service server 120a (S1010a). A signal processing server of the service server 120a may receive the SMS transmission request to transmit the SMS transmission request to a message processing server, and the message processing server may convert and classify SMS messages into app messages to transmit the converted app messages to the app server (S1020a). The app messages in operation S1020a may be information classified by the date received, the time received, the transmitter information, and the category (content) for each message by analyzing the content of each SMS message, as described in FIG. 5. In an embodiment, a second response message may include a message for a response corresponding to a voice message provided to the reception terminal 110 and further include a message for a response corresponding to a text message provided to the reception terminal 110. Therefore, the app server may provide second response messages corresponding to the plurality of text messages to the reception terminal 110. Further, the reception terminal 110 may input or transmit a confirmation notification indicating that the response messages are confirmed through the app (S1040a), and provide an SMS confirmation notification notifying that the receiver account confirms the response messages to the transmission terminal 140 through the telecommunications company server 120 (S1050a). Therefore, since the transmission terminal 140 that requested message transmission can also receive the confirmation notification for the receiver account, the satisfaction of all a plurality of users corresponding to the transmitter account and receiver account can be improved.

### Second embodiment

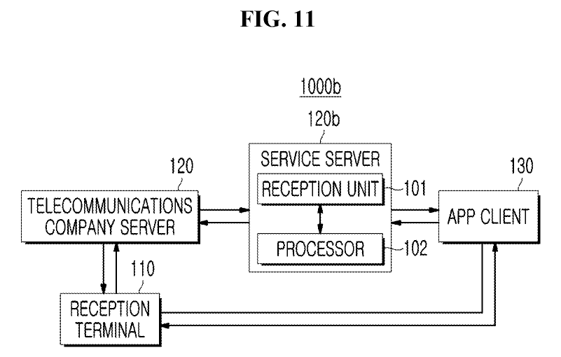

FIG. 11 is a block diagram schematically illustrating a configuration of a system 1000b for providing a service-related message as identity authentication is performed according to a second embodiment of the present disclosure.

Referring to the drawing, the system 1000b for providing the service-related message as the identity authentication is performed may include a service server 120b. In an embodiment, the service server 120b may be operated as the same server through inter-server linkage with a telecommunications company server 120, but in an embodiment, the service server 120b and the telecommunications company server 120 are integrated and indicated as the service server 120b. In an embodiment, the service server 120b may include a reception unit 101 and a processor 102. The reception unit 101 may receive a service provision request for requesting provision of an overseas notification service from a receiver account corresponding to a reception terminal 110. Further, upon receiving the service provision request, the processor 102 may determine whether the receiver account is subscribed to the overseas notification service. When the receiver account is subscribed to the overseas notification service, the processor 102 may perform first identity authentication on the receiver account using an ID and a password, and when the first identity authentication is performed normally, perform second identity authentication on the receiver account using at least one of a pre-designated keyword, an access IP band, location information, and an email address. When the second identity authentication is performed, the processor 102 may determine whether a timeout occurs based on a time count situation in which a count starts according to the type of USIM inserted into the reception terminal 110, and when the timeout does not occur, provide a message indicating that the overseas notification service is provided to the receiver account.

In an embodiment, the service server 120b may provide a service-related message to the reception terminal 110 through an app client 130. In an embodiment, upon receiving the service provision request from the reception terminal 110, the service server 120b may be operated in conjunction with the app client 130, and accordingly, service-related message provision processing may be performed on the receiver account after identity authentication is performed. The app client 130 may support an app service capable of storing or generating a plurality of messages to the reception terminal 110 and receive various information from an app server within the service server 120b. That is, the system 1000b for providing the service-related message as the identity authentication is performed according to an embodiment may be operated by including the service server 120b, the telecommunications company server 120, and the app client 130.

Further, in the process in which the service server 120b within the system 1000b for providing the service-related message as the identity authentication is performed receives a service provision request from the reception terminal 110 through the app client 130, determines whether the receiver account is subscribed to the overseas notification service to perform the identity authentication, and provides a message indicating that the overseas notification service is provided to the app client 130 according to a result of the identity authentication, it should be noted that the components of the system 1000b may be combined by a combination of various conventional networks such as the Internet, mobile communication networks, mobile communication exchange servers, etc., and there are no specific restrictions on this.

In addition, it will be understood by those skilled in the art that other general components other than those illustrated in FIG. 11 may be further included in the system 1000b for providing the service-related message as the identity authentication is performed. For example, the system 1000b for providing the service-related message as the identity authentication is performed may further include a telecommunications company server 120 corresponding to the reception terminal 110, a supplementary service server that checks whether the receiver account is subscribed to the overseas notification service, an identity authentication server that performs identity authentication on the receiver account, a media server that obtains voice signals and processes media information, a web server that obtains and stores voice files, text files, etc., obtained through the voice signals, or the like. Alternatively, according to another embodiment, it will be understood by those skilled in the art that some of the components illustrated in FIG. 11 may be omitted.

Here, the service server 120b is connected to communicate with an arbitrary internal component or at least one arbitrary external terminal via a wired/wireless communication network. In this case, the arbitrary external terminal may include the telecommunications company server 120, the app client 130, the reception terminal 110, etc. Here, wireless Internet technologies may include a WLAN, DLNA, a WiBro, WiMAX, HSDPA, HSUPA, IEEE 802.16, LTE, LTE-A, a WMBS, 5G mobile communication service, Bluetooth, RFID, IrDA, UWB, Zigbee, NFC, USC, VLC, Wi-Fi, Wi-Fi Direct, LoRa, etc., and the telecommunications company server 120 transmits or receives data according to at least one wireless Internet technology, including Internet technologies not listed above. Further, wired communication technologies may include PLC, USB communication, Ethernet, serial communication, optical/coaxial cables, etc. Further, a communication unit may exchange information with an arbitrary terminal through the USB. Further, the telecommunications company server 120 transmits or receives wireless signals to or from a base station, a response message providing server, the service server 120b, the app client 130, the reception terminal 110, etc. on a mobile communication network constructed according to technical standards or communication methods for mobile communication (e.g., GSM, CDMA, CDMA2000, Enhanced Voice-Data Optimized or EVDO, WCDMA, HSDPA, HSUPA, LTE, LTE-A, etc.).

The system 1000b for providing the service-related message as the identity authentication is performed according to an embodiment may be operated upon receiving a service provision request from a plurality of reception terminals 110, may be linked with any type of handheld-based wireless communication device equipped with a touch screen panel, such as a mobile phone, a smartphone, a PDA, a PMP, a tablet PC, etc., and in addition, may be used for message transmission through a system that includes or is linked with a device that has a foundation for installing and executing an application, such as a desktop PC, a tablet PC, a laptop PC, or an IPTV including a set-top box.

The system 1000b for providing the service-related message as the identity authentication is performed may be implemented as a server, such as a computer or the like, that operates through a computer program to realize the functions described in this specification.

The system 1000b for providing the service-related message as the identity authentication is performed according to an embodiment may include an identity authentication-related server (not illustrated), but the present disclosure is not limited thereto. The server according to an embodiment may support an application that performs identity authentication and supports a message provision service.

Hereinafter, the description will focus on an example in which the service server 120b that operates in the system 1000b for providing the service-related message as the identity authentication is performed according to an embodiment independently performs identity authentication and provides messages related to the overseas notification service, but as described above, the identity authentication may be performed through linkage with a plurality of servers included in the system 1000b for providing the service-related message as the identity authentication is performed. That is, it can be seen that the plurality of servers included in the system 1000b for providing the service-related message as the identity authentication is performed according to an embodiment may be implemented in an integrated manner in terms of their functions, or may be omitted, and the present disclosure is not limited to any one embodiment.

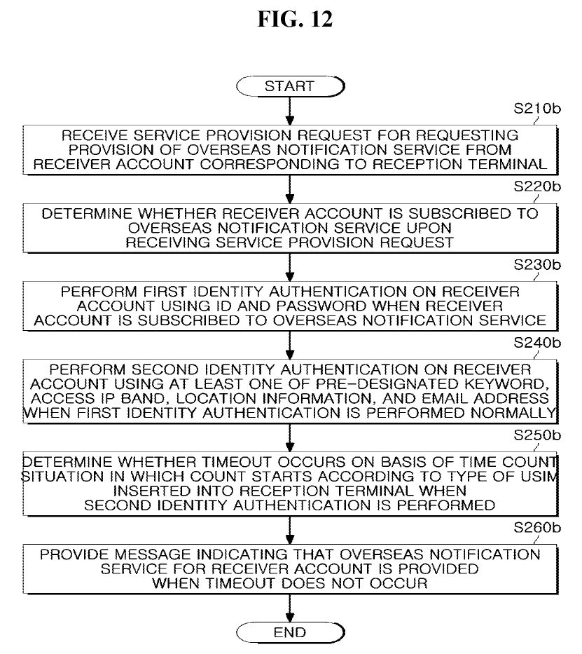

FIG. 12 is a flowchart schematically illustrating respective operations of providing a message indicating that an overseas notification service for a receiver account is provided in the system 1000b for providing the service-related message as the identity authentication is performed according to the second embodiment of the present disclosure.

Referring to operation S210b, the service server 120b according to an embodiment may receive a service provision request for requesting provision of an overseas notification service from a receiver account corresponding to the reception terminal 110. For example, the service provision request is a signal requested through the app client 130 of the reception terminal 110, and may include an example in which the receiver account transmits a login request to an app supported by the service server 120b in order to receive the overseas notification service. That is, the receiver account may transmit the service provision request to the service server 120b requesting provision of the overseas notification service in order to receive a message transmitted from overseas to a phone number corresponding to the reception terminal 110 in the country. In an embodiment, the service provision request may be requested through an app, and when the service provision request is made, an USIM for domestic use (an USIM corresponding to a domestic telecommunications company) may be installed in the reception terminal 110.

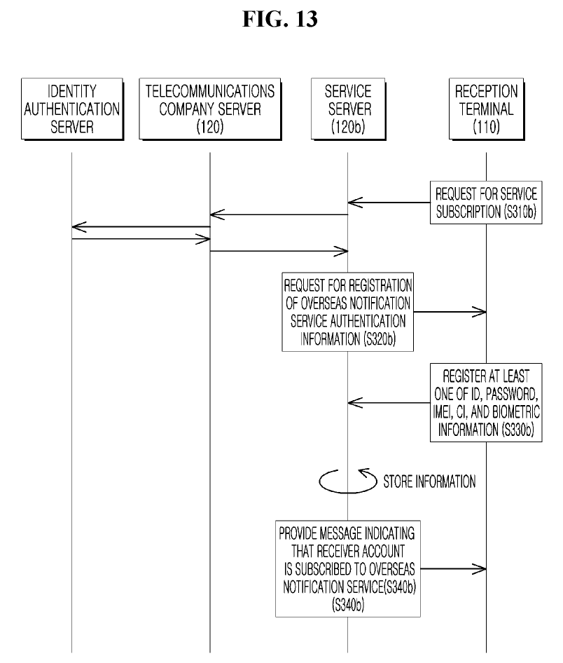

Referring to operation S220b, the service server 120b according to an embodiment may determine whether the receiver account is subscribed to the overseas notification service upon receiving the service provision request. The service server 120b may determine whether the receiver account is subscribed to the overseas notification service based on the USIM for domestic use installed in the reception terminal 110 for which service provision is requested in operation S210b. That is, the overseas notification service is a service supported by the telecommunications company server 120 in the country, and may determine whether the receiver account is subscribed to the overseas notification service according to personal information corresponding to the USIM for domestic use installed in the reception terminal 110. In an embodiment, the service server 120b may determine whether the receiver account is subscribed to an overseas service upon receiving a service subscription request from the receiver account. This will be described with reference to FIG. 13.

FIG. 13 is a flowchart schematically illustrating respective operations of determining whether the receiver account is subscribed to the overseas notification service as the service server 120b receives the service subscription request from the reception terminal 110 according to the second embodiment of the present disclosure.

In an embodiment, when the receiver account is not subscribed to the overseas notification service, the service server 120b may receive a service subscription request for requesting subscription to the overseas notification service from the receiver account corresponding to the reception terminal 110 (S310b). The service server 120b and the telecommunications company server 120 may be linked to determine whether the receiver account corresponding to the reception terminal 110 is subscribed to the overseas notification service through an identity authentication server, and the service server 120b may transmit a request for registration of overseas notification service authentication information to the reception terminal 110 upon receiving the service subscription request (S320b). Therefore, the service server 120b may obtain registration information including at least one of an ID, a password, IMEI, CI, and biometric information from the reception terminal 110 (S330b). The IMEI may be a unique identification number for each terminal, and the CI may be an online resident registration number and uniquely assigned to each receiver account. The service server 120b may obtain registration information for using the overseas notification service from the receiver account, and upon obtaining the registration information, determine that the receiver account is subscribed to the overseas notification service, and provide a message indicating that the receiver account is subscribed to the overseas notification service (S340b). In an embodiment, the service subscription request may be requested from overseas through the reception terminal 110, or may be requested in advance in the country through the reception terminal 110 in order to use the overseas notification service. However, the service subscription request may be made while a USIM for domestic use is installed in the reception terminal 110. That is, the service subscription request may be received after a service provision request made from overseas through the reception terminal 110, or may be received before the service provision request. In an embodiment, the message may include a message provided to the reception terminal 110, but the present disclosure is not limited thereto. For example, the message may include a message for storing service subscription information for each receiver account within the service server 120b. That is, the message may be directly transmitted to the reception terminal 110 as a message indicating that the receiver account is subscribed to the overseas notification service, or may be stored as a plurality of different pieces of information, such as authentication information indicating completion of subscription for each receiver account, a bit stream constituting an encoded representation of an additional information message, etc., internally in the service server 120b without separate transmission. That is, information on which whether each receiver account is subscribed may be confirmed may be stored within the service server 120b or a separate server linked with the service server 120b.

Referring to operation S230b, the service server 120b according to an embodiment may perform first identity authentication on the receiver account using an ID and a password when the receiver account is subscribed to the overseas notification service. In an embodiment, the ID and the password are registration information and may be information pre-obtained from the reception terminal 110. Therefore, the service server 120b may perform the first identity authentication using the ID and password of the receiver account that are input through the reception terminal 110. In an embodiment, the first identity authentication may be a process performed while a USIM for domestic use is installed in the reception terminal 110, or may be a process performed while a USIM for overseas use is installed. For example, the receiver account accesses the overseas notification service from overseas by entering an ID and a password through an app that supports the overseas notification service while a USIM for domestic use is installed in the reception terminal 110, and thus identification of the receiver account corresponding to the USIM for domestic use may be performed. Further, the receiver account accesses the overseas notification service from overseas by entering the ID and the password through the app that supports the overseas notification service while the USIM for domestic use installed in the reception terminal 110 is replaced with the USIM for overseas use, and thus identification may be performed to determine whether the receiver accounts corresponding to the USIM for domestic use and the USIM for overseas use are the same.

Referring to operation S240b, the service server 120b according to an embodiment may perform second identity authentication on the receiver account using at least one of a pre-designated keyword, an access IP band, location information, and an email address when the first identity authentication is performed normally. In an embodiment, the second identity authentication may be a process performed while a USIM for overseas use is installed in the reception terminal 110 after the first identity authentication is performed. The service server 120b may perform the second identity authentication on the receiver account by requesting input of the pre-designated keyword, requesting a reply and/or authentication input through the email address, or checking the access IP band and location information while the USIM for overseas use is installed in the reception terminal 110.

Referring to operation S250b, the service server 120b according to an embodiment may determine whether a timeout occurs based on a time count situation in which a count starts according to the type of USIM inserted into the reception terminal 110 when the second identity authentication is performed. In an embodiment, the service server 120b may start the count when the USIM inserted into the reception terminal 110 is a USIM for overseas use. Specifically, the count may start after the second identity authentication is performed while the USIM for overseas use is installed in the reception terminal 110. That is, the service server 120b may determine whether the timeout occurs based on the time count situation in which the count starts when the type of USIM inserted into the reception terminal 110 is the USIM for overseas use. In an embodiment, the time count situation may indicate a time elapsed since the count started. Further, the timeout may occur when a certain reference time is exceeded after which it is determined that the first identity authentication and/or the second identity authentication should be re-performed.

Referring to operation S260b, the service server 120b according to an embodiment may provide a message indicating that the overseas notification service for the receiver account is provided when the timeout does not occur. The case in which the timeout does not occur is a case in which a certain reference time has not elapsed since the second identity authentication is performed, and may be a case in which it is determined that there is no need to re-perform the first identity authentication and/or the second identity authentication. Therefore, the service server 120b may provide the overseas notification service for the receiver account.

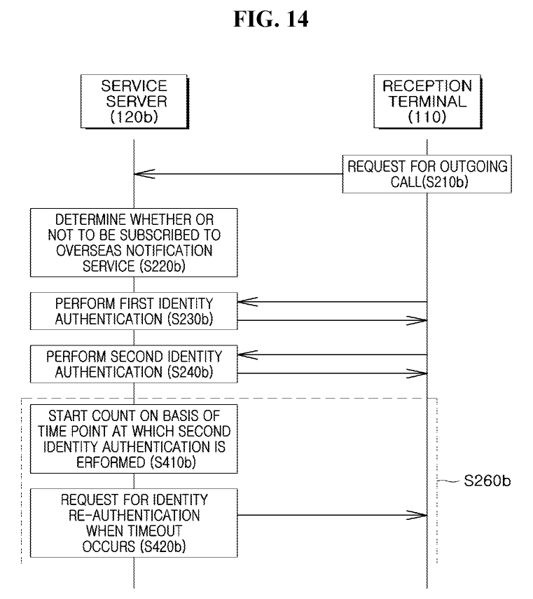

The service server 120b according to an embodiment may perform identity re-authentication using the USIM for domestic use inserted into the reception terminal 110 when the timeout occurs. This will be described with reference to FIG. 14.

FIG. 14 is a flowchart schematically illustrating respective operations of requesting, by the service server 120b, identity re-authentication from the reception terminal 110 according to the second embodiment of the present disclosure.

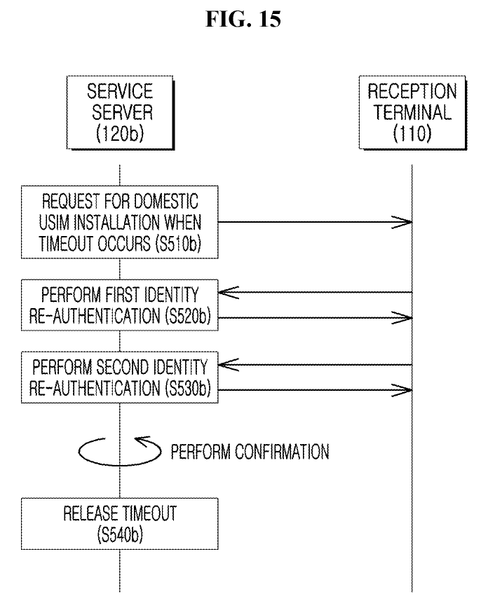

The service server 120b according to an embodiment may receive a service provision request from the reception terminal 110 (S210b) and determine whether the receiver account is subscribed to the overseas notification service (S220b). Further, when the receiver account is subscribed to the overseas notification service, first identity authentication may be performed on the receiver account corresponding to the reception terminal 110 (S230b), and after the first identity authentication is completed, second identity authentication may be performed (S240b). The service server 120b may start a count based on a time point at which the second identity authentication is performed (S410b). That is, the service server 120b may perform a count of the elapsed time from a time point at which the second identity authentication is completed. The service server 120b may determine that a timeout has occurred and request identity re-authentication of the receiver account when the count starts based on a time count situation and a preset period of time has elapsed, (S420b). In an embodiment, the preset period of time may be a period of time corresponding to the above-described fixed reference time. That is, the service server 120b may determine that a timeout has occurred when the count has started and the preset period of time has elapsed. Therefore, the first identity authentication and the second identity authentication may be re-performed by performing identity re-authentication on the receiver account using the USIM for domestic use according to the identity re-authentication request (S420b). This will be described with reference to FIG. 15.

FIG. 15 is a flowchart schematically illustrating an example in which the service server 120b performs identity re-authentication on a receiver account corresponding to the reception terminal 110 according to the second embodiment of the present disclosure.

When the service server 120b according to an embodiment performs an identity re-authentication request (S420b), the service server 120b may transmit a domestic USIM installation request (S510b) to the reception terminal 110. Here, the identity re-authentication request (S420b) and the domestic USIM installation request (S510b) may be provided through the app client 130 of the reception terminal 110. Further, the service server 120b may perform first identity re-authentication (S520b) when a USIM for domestic use is installed in the reception terminal 110, and perform second identity re-authentication (S530b) after the first identity re-authentication is completed. In an embodiment, the first identity re-authentication and the second identity re-authentication processes may be authentication processes in the same manner (authentication using an ID, a password, a pre-designated keyword, an access IP band, location information, and an email address) as the first identity re-authentication and the second identity re-authentication processes performed when a USIM for overseas use is installed in the reception terminal 110, or may be processes performed while the USIM for domestic use is installed in the reception terminal 110. That is, the service server 120b may release the timeout when the identity authentication of the receiver account is completed by performing the first identity re-authentication (S520b) and the second identity re-authentication (S530b) while the USIM for domestic use is installed in the reception terminal 110 and (S540b). Therefore, when the timeout is released, the service server 120b may provide a message indicating that the overseas notification service is provided when the USIM for overseas use is installed in the reception terminal 110 and the app is executed. In another embodiment, the service server 120b may update the preset period of time corresponding to the timeout based on the number of times of first identity authentication and the number of times of second identity authentication. For example, a high number of times of first identity authentication and a high number of times of second identity authentication may indicate a high frequency of use of the overseas notification service. Therefore, when the number of times of first identity authentication or the number of times of second identity authentication exceeds a reference number of times per period, the preset period of time may be updated to be a longer period of time. For example, in an embodiment, the reference number of times per period may mean the number of times the first identity authentication or the second identity authentication is performed within a month at one-month intervals from the time point at which the first identity authentication is performed while the USIM for overseas use is installed in the reception terminal 110. In an embodiment, the number of times of first identity authentication and the number of times of second identity authentication may be the same, but may be different depending on the situation. For example, the first identity authentication may be performed by another person using an ID and a password, but there may be a situation in which the second identity authentication, which is a more detailed authentication method, is not performed, and thus the number of times of first identity authentication and the number of times of second identity authentication may be different from each other. When both of the number of times of the first and second identity authentication within a month exceed a first number of times (e.g., three times), the period of time for determining the timeout may be updated to a second period of time corresponding to twice the first period of time representing a preset period of time. Further, when at least one of the number of times of first identity authentication and the number of times of second identity authentication within a month exceeds the first number of times, the period of time for determining the timeout may be updated to a third period of time corresponding to 1.5 times the first period of time. Conversely, when both of the number of times of the first and second identity authentication within a month is less than or equal to a second number of times (e.g., one time), the period of time for determining the timeout may be updated to a fourth period of time corresponding to half the first period of time. Except in the above-described situations, the period of time for determining the timeout may be maintained to be the first period of time.

In another embodiment, different weights may be assigned to the number of times of first identity authentication and the number of times of second identity authentication. For example, the number of times of second identity authentication may be given a higher weight than the number of times of first identity authentication. Since the importance and accuracy of the second identity authentication may be higher than those of the first identity authentication, the preset period of time corresponding to the timeout may be updated by assigning a higher weight to the number of times of second identity authentication. For example, since the first identity authentication is performed prior to the second identity authentication, the number of times of second identity authentication may be less than, equal to, or greater than the number of times of first identity authentication, depending on the situation, and thus the authentication completion result may be more variable, which may make the importance higher. For example, when a ratio of the number of times of second identity authentication to the number of times of first identity authentication corresponds to 1, the preset period of time may be maintained to be the first period of time, and when the ratio of the number of times of second identity authentication to the number of times of first identity authentication is less than or greater than 1, the preset period of time may be updated to be short. When the ratio of the number of times of second identity authentication to the number of times of first identity authentication is less than 1, a risk may be high as the first identity authentication is performed but the second identity authentication is not performed, and when the ratio of the number of times of second identity authentication to the number of times of first identity authentication exceeds 1, the risk may be high as there may be some cases in which the second identity authentication fails and re-authentication is attempted. Therefore, when the ratio of the number of times of second identity authentication to the number of times of first identity authentication is less than or greater than 1, the first period of time may be updated to a shorter period of time. For example, the case in which the ratio of the number of times of second identity authentication to the number of times of first identity authentication is less than 1 may include a situation in which the second identity authentication is not simply performed on the receiver account depending on the situation, but when the ratio exceeds 1, the probability of an incorrect answer for the second identity authentication may be high, and thus the risk in the case in which the ratio exceeds 1 may be higher. Therefore, when the ratio of the number of times of second identity authentication to the number of times of first identity authentication exceeds 1, the period of time for determining the timeout may be updated to a fourth period of time corresponding to half the first period of time. Further, when the ratio of the number of times of second identity authentication to the number of times of first identity authentication is less than 1, the period of time for determining the timeout may be updated to a fifth period of time corresponding to 0.8% of the first period of time. As described above, security can be improved by updating the preset period of time required to re-perform the identity authentication, for which whether the timeout occurs is determined, depending on the situation.

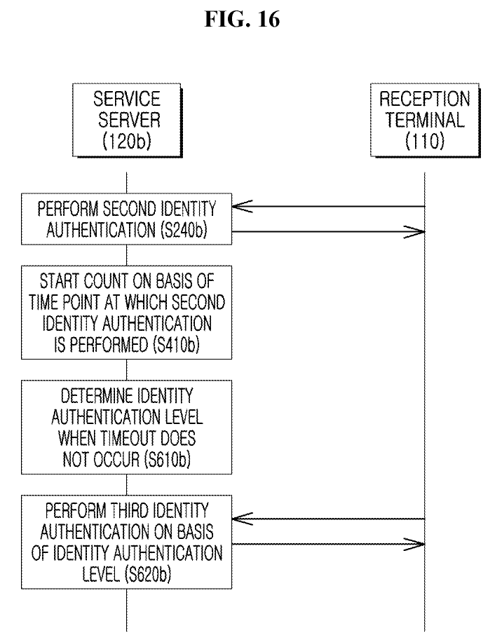

The service server 120b according to an embodiment may determine an identity authentication level based on the time count situation. This will be described with reference to FIG. 16.

FIG. 16 is a flowchart schematically illustrating an example in which the service server 120b performs third identity authentication on the receiver account corresponding to the reception terminal 110 according to the second embodiment of the present disclosure.

The service server 120b according to an embodiment performs second identity authentication on the receiver account corresponding to the reception terminal 110 (S240b) and starts a count based on a time point at which the second identity authentication is performed (S410b). When no timeout occurs, the service server 120b may determine an identity authentication level (S610b). In an embodiment, the identity authentication level may be a level determined to perform different authentications according to the time elapsed since the count has started. That is, the identity authentication level may be a level determined by the elapsed time before a preset period of time has elapsed based on the time count situation that progresses according to the start of the count. The service server 120b may perform third identity authentication based on the determined identity authentication level (S620b). For example, the service server 120b may perform the third identity authentication according to an additional authentication method corresponding to the identity authentication level of each receiver account. In an embodiment, the identity authentication level may be determined in proportion to an elapsed time exceeded as the start of the count progresses. That is, the longer the elapsed time representing the time elapsed since the start of the count, the higher the identity authentication level may be determined. For example, when the identity authentication level is Level 1, the service server 120b may perform identity authentication based on a pattern input that is input from the receiver account. Further, when the identity authentication level is Level 2, the service server 120b may perform identity authentication based on a fingerprint input that is input from the receiver account. Further, when the identity authentication level is Level 3, the service server 120b may perform identity authentication based on the pattern input and the fingerprint input that are input from the receiver account. In an embodiment, the identity authentication level may be higher in the order of Level 3, Level 2, and Level 1. In an embodiment, the preset period of time for determining whether the timeout occurs after the above-described count starts may be divided by a preset ratio to determine the identity authentication level to be one of the first to third levels. For example, the service server 120b may determine the identity authentication level to be Level 1 when the elapsed time since the start of the count is within a range of 1/4 of the preset period of time (a range of 25% or less). Further, the service server 120b may determine the identity authentication level to be Level 2 when the elapsed time since the start of the count is within a range of more than 1/4 and 3/4 of the preset period of time (a range of more than 25% and 75% or less). Further, the service server 120b may determine the identity authentication level to be Level 3 when the elapsed time since the start of the count is within a range of more than 3/4 and less than 4/4 of the preset period of time (a range of more than 75% and less than 100%). That is, when the identity authentication level of the receiver account is determined to be the lowest level, Level 1, based on the elapsed time, the service server 120b may request a pattern input from the reception terminal 110, and further perform third identity authentication based on the pattern input that is input from the receiver account to determine whether an overseas notification service is provided to the reception terminal 110 in which an USIM for overseas use is installed. Further, when the identity authentication level of the receiver account is determined to be Level 2, the service server 120b may request a fingerprint input capable of improving the accuracy of the receiver account compared to the pattern input from the reception terminal 110, and further perform third identity authentication based on the fingerprint input that are input from the receiver account. Further, when the identity authentication level of the receiver account is determined to be Level 3, the service server 120b may request both a pattern input and a fingerprint input from the reception terminal 110, and further perform third identity authentication based on the pattern input and the fingerprint input that are input from the receiver account. Therefore, as the elapsed time increases, the identity authentication level is determined to be higher, and thus the accuracy of identity authentication for the receiver account can be improved. In another embodiment, when the elapsed time since the start of the count is within a range of 1/8 of the preset period of time (a range of 12.5% or less) which is less than the range of 1/4 of the preset period of time (the range of 25% or less), the service server 120b may determine the identity authentication level to be Level 0 and may not perform separate third identity authentication. That is, when the elapsed time is shorter than a certain level, the overseas notification service may be provided to the reception terminal 110 without performing the third identity authentication when the first identity authentication and the second identity authentication have been performed. In another embodiment, the service server 120b may determine the identity authentication level further based on a difference between a first time point at which the first identity authentication is performed and a second time point at which the second identity authentication is performed. For example, the difference between the first time point and the second time point may include a time before the second identity authentication is performed, and the above-described elapsed time may include a time after the second identity authentication is performed. Specifically, the second identity authentication is performed using at least one of a pre-designated keyword, an access IP band, location information, and an email address, and in the case in which the second identity authentication is performed using the pre-designated keyword and the email address, the identity authentication level may be updated based on the difference between the first time point and the second time point. For example, when the ID and the password are input from the receiver account and the first identity authentication is performed, the second identity authentication may be performed, and when a request for input of a pre-specified keyword and a request for a reply and/or authentication input through an email address is made to the reception terminal 110, the later a response time, which indicates a time at which a response is input in response to the request, or the later a time at which the second identity authentication is completed, the higher the identity authentication level may be. For example, after the first identity authentication is performed, when the response time exceeds one day when performing the second identity authentication, or when the response is received but the authentication is not completed by the time exceeding one day (e.g., when a response input is incorrect), the identity authentication level may be updated to a higher level by one level. In this case, when the original identity authentication level was Level 3, the identity authentication level may be re-determined by re-performing the first identity authentication in which the ID and the password are input from the receiver account and the second identity authentication in which the reply using the pre-designated keyword and the email address are input from the receiver account, while the USIM for overseas use is installed in the reception terminal 110. Further, even when the response time exceeds one week when the second identity authentication is performed after performing the first identity authentication, the identity authentication level may be re-determined by re-performing the first identity authentication and the second identity authentication. Therefore, the security and stability of personal information of the receiver account can be further secured.

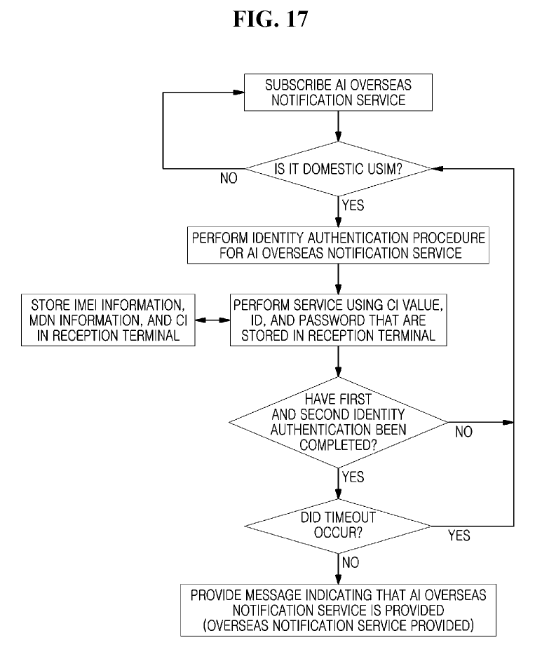

FIG. 17 is a flowchart illustrating the overall flow of the service server 120b that performs an identity authentication process and a service-related message provision process according to the second embodiment of the present disclosure.

Referring to FIG. 17, when the receiver account uses the reception terminal 110 overseas after the receiver account has been subscribed to an AI overseas notification service, and when an USIM for domestic use is installed in the reception terminal 110 overseas, an identity authentication procedure for an AI overseas notification service may be performed. In an embodiment, when the USIM for domestic use is not installed in the reception terminal 110 overseas after the receiver account has been subscribed to the AI overseas notification service, the identity authentication procedure may not be performed and the receiver account may return to the AI overseas notification service subscription state. That is, when the USIM for domestic use is installed in the reception terminal 110 overseas, the identity authentication procedure for an AI overseas notification service may be performed on the receiver account. Further, the service may be performed using a CI value, an ID, and a password that are stored in the reception terminal 110. That is, the service server 120b may store IMEI information, Mozilla Developer Network (MDN) information, and CI of the reception terminal 110 in which the USIM for domestic use is installed, and perform the first identity authentication and the second identity authentication on the receiver account using the stored information. Specifically, during the service execution process, the first identity authentication and the second identity authentication may be performed in a state in which the USIM of the reception terminal 110 has been replaced with an USIM for overseas use. When the first identity authentication and the second identity authentication are not completed, the service server 120b may request that the USIM for domestic use be re-installed in the reception terminal 110 to re-perform the identity authentication procedure. Further, when the first identity authentication and the second identity authentication are completed, the service server 120b may determine whether a timeout occurs from a time point at which the second identity authentication is completed. When the timeout occurs, the service server 120b may request that the USIM for domestic use be re-installed in the reception terminal 110 to re-perform the identity authentication procedure. Further, when the timeout does not occur, the service server 120b may provide a message indicating that the AI overseas notification service is provided. Therefore, the receiver account may receive the message received by the account in the country through the reception terminal 110 overseas.

According to an embodiment, user satisfaction can be improved by reducing the burden of large roaming charges that may arise during long-term stays abroad. Further, when providing the overseas notification service, security can be improved by performing the first identity authentication and the second identity authentication, and security can be further secured by further performing identity re-authentication based on the time count situation. Further, both user convenience and security can be secured by further performing third identity authentication for each level of difficulty according to the additional authentication method corresponding to the identity authentication level.

### Third embodiment

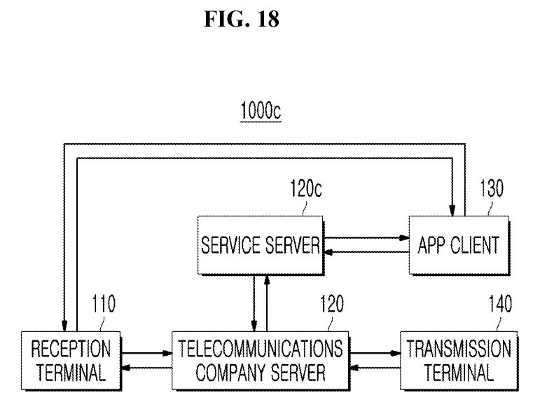

FIG. 18 is a block diagram schematically illustrating a configuration of a system 1000c for providing a response message according to transmitter account authentication according to a third embodiment of the present disclosure.

Referring to the drawing, the system 1000c for providing the response message according to transmitter account authentication may include a telecommunications company server 120 and a service server 120c. In an embodiment, the telecommunications company server 120 and the service server 120c may be performed on the same server through inter-server linkage, but are differently indicated as the telecommunications company server 120 or the service server 120c according to a subject on which various operations are performed. In an embodiment, the telecommunications company server 120 may receive, from a transmission terminal 140, an outgoing call request for transmitting a plurality of voice messages to a reception terminal 110. Further, upon receiving the outgoing call request, the telecommunications company server 120 may determine whether a receiver account corresponding to the reception terminal 110 is subscribed to an overseas notification service. Further, when the receiver account is subscribed to the overseas notification service, the telecommunications company server 120 may route a line connection between the reception terminal 110 and the transmission terminal 140 to pass through the service server 120c.

The service server 120c according to an embodiment may obtain transmitter account characteristic information including at least one of a transmitter nationality, a transmitter communication network, and a transmitter phone number for a transmitter account corresponding to the transmission terminal 140. Further, the service server 120c may determine a call processing method including at least one of an additional notification type, a transmission priority, a type of network used for transmission, and a format of a message to be transmitted for the plurality of voice messages based on the transmitter account characteristic information. Further, the service server 120c may provide response messages corresponding to the plurality of voice messages to the reception terminal 110 according to the call processing method.

In an embodiment, the service server 120c may transmit the response messages to an app client 130 of the reception terminal 110. The app client 130 may be a device that supports an app service to the reception terminal 110. The response messages may be provided to the receiver account through the app client 130. In an embodiment, when a message transmission request is obtained between the reception terminal 110 and the transmission terminal 140, the telecommunications company server 120, the service server 120c, and the app client 130 may be operated in conjunction with each other, and thus response message processing may be performed on the plurality of voice messages. The app client 130 may support an app service, which can store or generate a response message in response to the message transmission request to the reception terminal 110, and receive various information from the app server within the service server 120c. That is, the server according to an embodiment may be operated by including the service server 120c, the telecommunications company server 120, and the app client 130.

Further, in the process in which the telecommunications company server 120 in the system 1000c for providing the response message according to transmitter account authentication receives an outgoing call request and determines whether a receiver account is subscribed to the overseas notification service, and the service server 120c determines the call processing method using the transmitter account characteristic information and transmits the response message in response to the message transmission request to the app client 130 according to the determined call processing method, it should be noted that the components of the system 1000c may be combined by a combination of various conventional networks such as the Internet, mobile communication networks, mobile communication exchange servers, etc., and there are no specific restrictions on this.

In addition, it will be understood by those skilled in the art that other general components other than those illustrated in FIG. 18 may be further included in the system 1000c for providing the response message according to transmitter account authentication. For example, the system 1000c for providing the response message according to transmitter account authentication may further include a telecommunications company server 120 corresponding to the reception terminal 110, a supplementary service server that checks whether the receiver account is subscribed to the overseas notification service, a media server that obtains voice signals and processes media information when a call is connected, a web server that obtains and stores voice files, text files, etc. obtained through the voice signals, or the like. Alternatively, according to another embodiment, it will be understood by those skilled in the art that some of the components illustrated in FIG. 18 may be omitted.

Here, the telecommunications company server 120 is connected to communicate with an arbitrary internal component or at least one arbitrary external terminal via a wired/wireless communication network. In this case, the arbitrary external terminal may include the service server 120c, the app client 130, the reception terminal 110, etc. Here, wireless Internet technologies may include a WLAN, DLNA, a WiBro, WiMAX, HSDPA, HSUPA, IEEE 802.16, LTE, LTE-A, a WMBS, 5G mobile communication service, Bluetooth, RFID, IrDA, UWB, Zigbee, NFC, USC, VLC, Wi-Fi, Wi-Fi Direct, LoRa, etc., and the telecommunications company server 120 transmits or receives data according to at least one wireless Internet technology, including Internet technologies not listed above. Further, wired communication technologies may include PLC, USB communication, Ethernet, serial communication, optical/coaxial cables, etc. Further, a communication unit may exchange information with an arbitrary terminal through the USB. Further, the telecommunications company server 120 transmits or receives wireless signals to or from a base station, a response message providing server, the service server 120c, the app client 130, the reception terminal 110, etc. on a mobile communication network constructed according to technical standards or communication methods for mobile communication (e.g., GSM, CDMA, CDMA2000, Enhanced Voice-Data Optimized or EVDO, WCDMA, HSDPA, HSUPA, LTE, LTE-A, etc.).

The system 1000c for providing the response message according to transmitter account authentication according to an embodiment may be used when a plurality of transmission terminals 140 request message transmission to the reception terminal 110, may be linked with any type of handheld-based wireless communication device equipped with a touch screen panel, such as a mobile phone, a smartphone, a PDA, a PMP, a tablet PC, etc., and in addition, may be used for message transmission through a system that includes or is linked with a device that has a foundation for installing and executing an application, such as a desktop PC, a tablet PC, a laptop PC, or an IPTV including a set-top box.

The system 1000c for providing the response message according to transmitter account authentication may be implemented as a server, such as a computer or the like, that operates through a computer program to realize the functions described in this specification.

The system 1000c for providing the response message according to transmitter account authentication according to an embodiment may include a transmitter account authentication server (not illustrated), but the present disclosure is not limited thereto. The server according to an embodiment may support an application that provides a message transmission service according to transmitter account authentication.

Hereinafter, the description will focus on an embodiment in which the server that operates in the system 1000c for providing the response message according to transmitter account authentication according to an embodiment independently performs authentication for the transmitter account and provides the response message, but as described above, the server may be performed through linkage with a plurality of servers included in the system 1000c for providing the response message according to transmitter account authentication. That is, it can be seen that the plurality of servers included in the system 1000c for providing the response message according to transmitter account authentication according to an embodiment may be implemented in an integrated manner in terms of their functions, or may be omitted, and the present disclosure is not limited to any one embodiment.

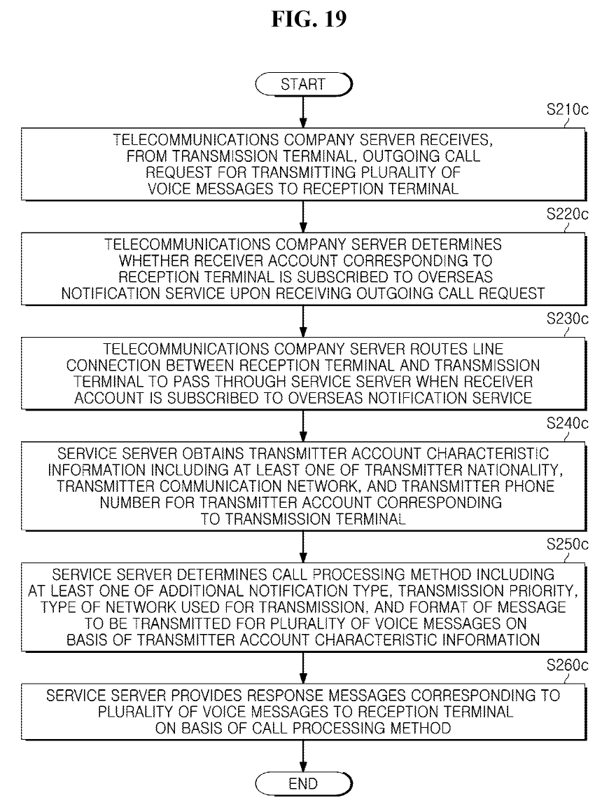

FIG. 19 is a flowchart schematically illustrating respective operations of providing a response message to a reception terminal 110 in the system 1000c for providing the response message according to transmitter account authentication according to the third embodiment of the present disclosure.

Referring to operation S210c, the telecommunications company server 120 according to an embodiment may receive, from the transmission terminal 140, an outgoing call request for transmitting a plurality of voice messages to the reception terminal 110. In an embodiment, the plurality of voice messages may include voice signals according to call connections. The telecommunications company server 120 may include a telecommunications company server 120 corresponding to a receiver account and a telecommunications company server 120 corresponding to a transmitter account and support call connections corresponding to the plurality of voice messages by making mobile communications through one or more telecommunications company servers 120. Therefore, the telecommunications company server 120 may receive, from the transmission terminal 140, the outgoing call request requested to the reception terminal 110. In an embodiment, an example in which the outgoing call request for transmitting the plurality of voice messages is received by the reception terminal 110 is illustrated as an embodiment, but the present disclosure is not limited thereto and may further include an example in which an outgoing call request for transmitting a plurality of text messages is received in addition to the plurality of voice messages.

Referring to operation S220c, the telecommunications company server 120 according to an embodiment may determine whether a receiver account corresponding to the reception terminal 110 is subscribed to an overseas notification service upon receiving the outgoing call request. In an embodiment, the overseas notification service may include a service that allows the receiver account overseas to receive response messages corresponding to the plurality of voice messages in response to at least one outgoing call request that is requested from the transmission terminal 140 in the country or to the reception terminal 110 corresponding to the receiver account in the country when the reception terminal 110 is located overseas. This may be an example of providing a response message in response to at least one outgoing call request received by the reception terminal 110 corresponding to the receiver account in the country to the reception terminal 110 overseas, for the receiver account that uses the telecommunications company server corresponding to the server according to an embodiment. In an embodiment, the telecommunications company server 120 may determine whether the receiver account is subscribed to the overseas notification service when the location of the reception terminal 110 is determined to be overseas. For example, the telecommunications company server 120 may check whether the receiver account is subscribed to the overseas notification service based on the location of the reception terminal 110. That is, the telecommunications company server 120 and the service server 120c do not support the overseas notification service when the location of the reception terminal 110 is domestic, and may support the overseas notification service when the location of the reception terminal 110 is overseas.

Referring to operation S230c, the telecommunications company server 120 according to an embodiment may route a line connection between the reception terminal 110 and the transmission terminal 140 to pass through the service server 120c when the receiver account is subscribed to the overseas notification service. When the receiver account is subscribed to the overseas notification service, the telecommunications company server 120 may be linked with the service server 120v to support the line connection and may support a notification service for the plurality of voice messages. In an embodiment, when the telecommunications company server 120 routes the line connection between the reception terminal 110 and the transmission terminal 140 to pass through the service server 120c according to whether the receiver account is subscribed the overseas notification service, the app client 130 may be further linked and operated through the service server 120c. For example, the service server 120c may further include an app server, and the app client 130 may be linked and operated by controlling the app server.

Referring to operation S240c, the service server 120c according to an embodiment may obtain transmitter account characteristic information including at least one of a transmitter nationality, a transmitter communication network, and a transmitter phone number for a transmitter account corresponding to the transmission terminal 140. In an embodiment, the service server 120c may determine the transmitter nationality and the transmitter communication network for the outgoing call request received from the transmitter account by tracking the location of the transmission terminal 140 that receives the outgoing call request. Therefore, the service server 120c may obtain the transmitter nationality, the transmitter communication network, and the transmitter phone number for the transmitter account as the transmitter account characteristic information at a time point at which the outgoing call request is received.

Referring to operation S250c, the service server 120c according to an embodiment may determine a call processing method including at least one of an additional notification type, a transmission priority, a type of network used for transmission, and a format of a message to be transmitted for the plurality of voice messages based on the transmitter account characteristic information. In an embodiment, the additional notification type may include at least one of an emergency notification message, a voice file message, and an emergency transmitter notification message, and the message format may include at least one of a summary format, a text format, and a link processing format. Further, the type of network used for transmission may be one of a public network or a dedicated network. The public network is an overseas communication network corresponding to an overseas location of the receiver account, and may include an example of a message in the country being transmitted using the overseas communication network. This is because messages are transmitted to the receiver account overseas through the overseas communication network, the messages are transmitted in non-real time and has the characteristic of being transmitted slowly. Further, the dedicated network may be an example of allowing domestic communication networks to be used overseas, and in the dedicated network, messages in the country are transmitted through a domestic communication network that can be connected overseas, and thus the messages are transmitted rapidly when transmitted in real time. In an embodiment, the call processing method for the plurality of voice messages may be determined in different ways depending on the situation. For example, some voice messages among the plurality of voice messages may be determined using a call processing method in which any one of the types of additional notifications is applied, and the messages may be transmitted according to transmission priority. Further, each of the plurality of voice messages may be determined using a call processing method in which different types of networks used for transmission are applied, or may be determined using a call processing method in which any one of the message formats to be transmitted is applied. Further, depending on the situation, separate additional notification types and message formats may not be applied, and the plurality of voice messages may be transmitted sequentially based on the time point of reception without determining a separate transmission priority. Furthermore, depending on the situation, any one of the elements included in the above-described call processing method may be applied to transmit the plurality of voice messages, and two or more elements may be applied in duplicate to transmit the plurality of voice messages. For example, the service server 120c may determine the call processing method based on whether the transmitter phone number is a number pre-stored in the reception terminal 110. When the transmitter phone number in the transmitter account characteristic information is a number pre-stored in the reception terminal 110, the need for transmission to the reception terminal 110 may be high, and thus the additional notification type, the transmission priority, the type of network used for transmission, and the format of the message to be transmitted may be determined based on whether the number is pre-stored. Therefore, the service server 120c may provide response messages to the reception terminal 110 according to the determined call processing method.

Referring to operation S260c, the service server 120c according to an embodiment may provide response messages corresponding to the plurality of voice messages to the reception terminal 110 based on the call processing method. In an embodiment, the response messages may refer to messages in which the call processing method has been applied to each of the plurality of voice messages. Therefore, the service server 120c provides the response messages obtained according to the call processing method determined in operation S250c, to the reception terminal 110.

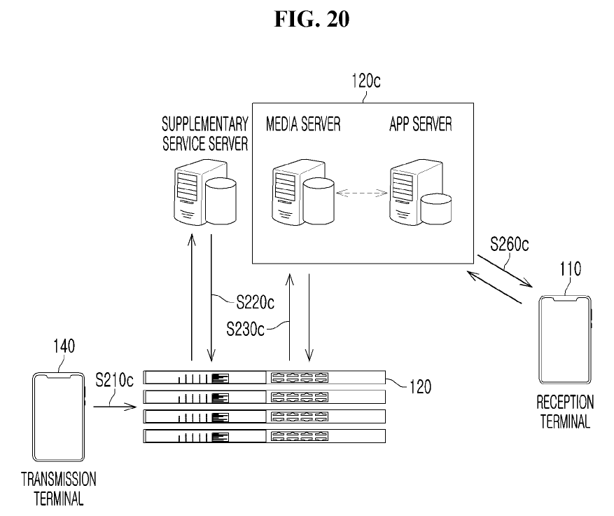

FIG. 20 is a flowchart schematically illustrating respective operations of providing the response message to the reception terminal 110 as the telecommunications company server 120 routes a line connection to pass through the service server 120c according to the third embodiment of the present disclosure.

Referring to FIG. 20, the service server 120c may include a media server and an app server. The media server may be a server that processes media information such as voice signals or voice messages, and the app server may be a server that is linked with the app client 130 that provides response messages. When an outgoing call request is received from the transmission terminal 140, the telecommunications company server 120 may determine whether the reception terminal 110, which is a target of message transmission, is subscribed to an overseas notification service. The telecommunications company server 120 may determine whether the receiver account is subscribed to the overseas notification service through a supplementary service server (S220c). Therefore, when the receiver account is subscribed to the overseas notification service, the telecommunications company server 120 may route a line connection between the transmission terminal 140 and the reception terminal 110 to pass through the service server 120c (S230c). The media server may provide a response message to the reception terminal 110 through the app server by communicating with the app server in a mobile communication method (S260c). In an embodiment, the app server may be a server linked with the app client 130, but provide a response message to the reception terminal 110 in non-real time according to the connection to an overseas line.

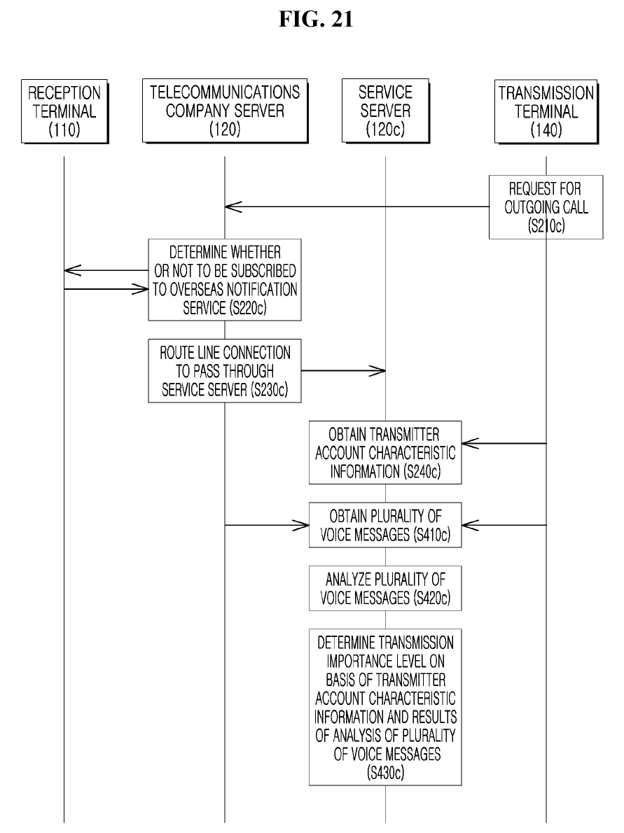

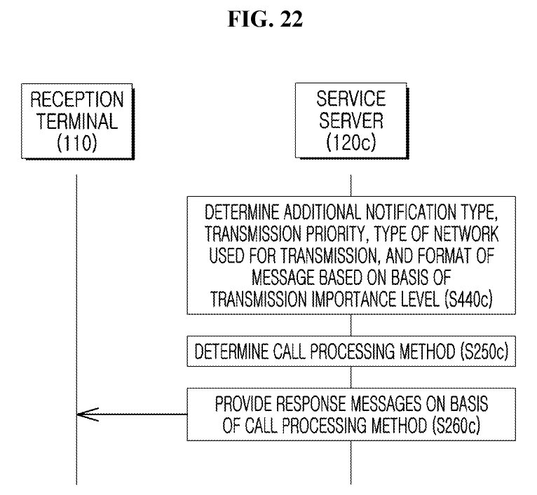

The service server 120c according to an embodiment may determine a transmission importance level for each of the plurality of voice messages when providing the response message to the reception terminal 110. This will be described with reference to FIGS. 21 and 22.

FIG. 21 is a flowchart schematically illustrating respective operations of determining, by a server, a transmission importance level according to the third embodiment of the present disclosure.

Referring to FIG. 21, the telecommunications company server 120 may receive an outgoing call request from the transmission terminal 140 (S210c) and determine whether the reception terminal 110 is subscribed to an overseas service (S220c). The telecommunications company server 120 may route a line connection between the transmission terminal 140 and the reception terminal 110 to pass through the service server 120c (S230c). The service server 120c may obtain transmitter account characteristic information for a transmitter account corresponding to the transmission terminal 140 (S240c). Accordingly, the service server 120c may determine a transmission importance level based on the transmitter account characteristic information and results of analysis of a plurality of voice messages. As illustrated in FIG. 21, the service server 120c may obtain the plurality of voice messages received from the transmission terminal 140 (S410c). Therefore, the service server 120c may analyze the plurality of voice messages (S420c). In an embodiment, the analysis of the voice message may include analysis of message content, analysis of a reception time, etc. The service server 120c may determine the transmission importance level based on the transmitter account characteristic information and the results of analysis of the plurality of voice messages (S430c).

FIG. 22 is a flowchart schematically illustrating respective operations of providing, by the server, the response message to the reception terminal 110 based on the transmission importance level according to the third embodiment of the present disclosure.

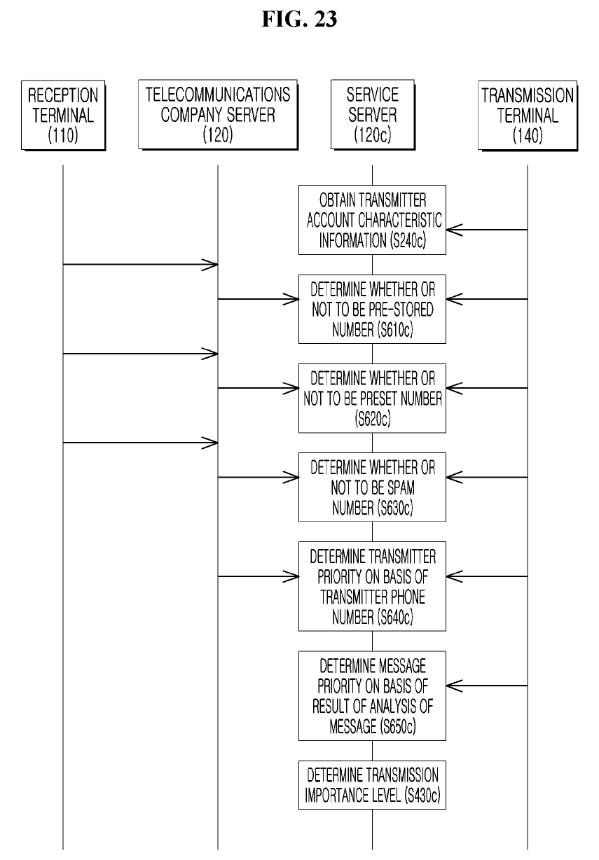

Referring to FIG. 22, the service server 120c may determine an additional notification type, a transmission priority, a type of network used for transmission, and a format of the message based on the transmission importance level (S440c). Therefore, the service server 120c may determine a call processing method in which the determined additional notification type, transmission priority, type of network used for transmission, and format of the message are applied (S250c). In an embodiment, various methods may be applied to the method of determining the transmission importance level. For example, the service server 120c may determine the transmission importance level based on whether the transmitter phone number is a number pre-stored in the reception terminal 110, whether the transmitter phone number is a preset number from the reception terminal 110, and whether the transmitter phone number is a spam number. This will be described with reference to FIG. 23.

FIG. 23 is a flowchart schematically illustrating respective operations of performing, by the server, a specific process that determines the transmission importance level according to the third embodiment of the present disclosure.

Referring to FIG. 23, the service server 120c according to an embodiment may obtain the transmitter account characteristic information for the transmission terminal 140 (S240c) and determine whether the transmitter phone number of the transmission terminal 140 is a pre-stored number in the reception terminal 110 (S610c). Further, the service server 120c may determine whether the transmitter phone number of the transmission terminal 140 is a preset number from the reception terminal 110 (S620c). In an embodiment, the preset number may be a number preset by the receiver account through an app linked with the service server 120c. For example, the receiver may preset at least one phone number that should be reached from overseas. Further, the service server 120c may determine whether the transmitter phone number of the transmission terminal 140 is a spam number. The service server 120c may be linked with the telecommunications company server 120 and determine whether the transmitter phone number is a spam number by communicating with a plurality of external servers in a mobile communication method (S630c). Therefore, the service server 120c may determine a transmitter priority according to whether the transmitter phone number is a pre-stored number, a preset number, or a spam number (S640c). Further, the service server 120c may determine message priorities based on the results of analysis of message content of the plurality of voice messages (S650c). Therefore, the service server 120c may determine a transmission importance level based on the transmitter priority and the message priorities (S430c). The message priorities are a result of analysis of the message content using AI and may be priorities determined in order of importance according to whether important text is included, how many times important text is included, etc. For example, the service server 120c may determine the transmitter priority to be high priority when the transmitter phone number corresponds to a pre-stored number and a preset number, and determine the transmitter priority to be low when the transmitter phone number corresponds to a spam number. The service server 120c may assign a higher weight to the transmitter priority than the message priority. For example, the service server 120c may determine the importance of the transmitter account corresponding to the transmitter phone number to be higher than the results of analysis of each of the plurality of voice messages, and thus may provide voice messages corresponding to the pre-stored number and the preset number to the reception terminal 110 preferentially. Specifically, the service server 120c may determine a transmission priority based on weights that are assigned to be gradually lowered in order of the preset number, the pre-stored number, and the result of analysis of the message content. In an embodiment, since the preset number is a phone number that the receiver account has preset that is considered important in advance, the preset number may be provided preferentially, and the phone number may be considered to correspond to a phone number of the transmitter with highest importance, and thus the highest weight may be assigned to the preset number. Further, the pre-stored number may be a phone number of the transmitter that has a relationship with the receiver account, and accordingly, the pre-stored number may be less risky and more likely to contain a required transmission message, and thus a second-highest weight may be assigned to the pre-stored number. Further, the result of analysis of the message content may be a factor to consider in that messages that should be provided preferentially may be identified according to the importance of the text included in the message content, but when considering only the message content, some spam messages may be contained so that the objectivity may be lower than the two factors described above, and thus a third-highest weight may be assigned to the result of analysis of the message content. Therefore, the service server 120c may determine the transmission priority according to the above-described method and provide response messages to which different types of additional notifications, different types of networks used for transmission, and different message formats are applied. For example, when the transmission importance level is higher than or equal to Level 1, the service server 120c may provide a response message to the reception terminal 110 through a dedicated network. In an embodiment, the dedicated network may be a network in which a method of transmitting messages using a domestic communication network connected to overseas is used. Level 1 may be a level that serves as a criterion for determining whether a message is of high importance. Therefore, the network used for transmission may be determined differently according to whether the transmission importance level is higher than or equal to Level 1. The service server 120c may provide a response message to the reception terminal 110 through a public network when the transmission importance level is lower than Level 1. The public network may be a network in which a method of transmitting messages using an overseas communications network is used. Therefore, messages with high importance may be provided to the reception terminal 110 preferentially through a dedicated network. Further, the service server 120c may sequentially provide a response message to the reception terminal 110 through a dedicated network when the transmission importance level is higher than or equal to Level 1 and is lower than Level 2 higher than Level 1. For example, at least one voice message having a transmission importance level that is higher than or equal to Level 1 may be provided to the reception terminal 110 preferentially compared to at least one voice message having a transmission importance level that is lower than Level 1. In this case, when at least one voice message that is higher than or equal to Level 1 is provided to the reception terminal 110, the response message corresponding to each voice message may be sequentially provided to the reception terminal 110 based on a time at which each message is received by the phone number corresponding to the receiver account in the country over time. When the transmission importance level is higher than or equal to Level 2 higher than Level 1, the service server 120c may provide the response message to the reception terminal 110 according to the transmission priority together with the additional notification type. That is, the service server 120c may sequentially provide response messages corresponding to a plurality of voice messages whose transmission importance levels are higher than or equal to Level 1 and are lower than Level 2 to the reception terminal 110 through the dedicated network, and provide response messages corresponding to the plurality of voice messages whose transmission importance levels are higher than or equal to Level 2 to the reception terminal 110 according to the transmission priority through the dedicated network. That is, the response messages corresponding to the plurality of voice messages whose transmission importance levels are higher than or equal to Level 2 may be transmitted to the reception terminal 110 preferentially compared to the response messages corresponding to the plurality of voice messages whose transmission importance levels are higher than or equal to Level 1 and are lower than Level 2. Separate transmission priorities may be determined for the plurality of voice messages whose transmission importance levels are higher than or equal to Level 2 so that the response messages may be transmitted to the reception terminal 110 according to the determined transmission priorities. In an embodiment, even when the response messages are provided to the reception terminal 110 through the dedicated network, the response messages may be transmitted based on a certain reference time. For example, rather than providing the response message to the reception terminal 110 corresponding to the receiver account overseas in real time through the dedicated network at each time point at which the voice message is received by the reception terminal 110 corresponding to the receiver account in the country, the response message may be provided through the dedicated network based on a preset reference time. For example, the service server 120c may determine transmission priorities of a plurality of voice messages received during one day and provide response messages to the reception terminal 110 according to the transmission priorities. Further, the service server 120c may provide the response messages to the reception terminal 110 by applying the additional notification type when the transmission importance level is higher than or equal to Level 2. In an embodiment, the additional notification type may include at least one of an emergency notification message, a voice file message, and an emergency transmitter notification message. The service server 120c may provide the response message together with the additional notification message to the reception terminal 110. Specifically, the service server 120c may determine an additional notification message to be applied among the emergency transmitter message, the emergency notification message, and the voice file message for a plurality of voice messages whose transmission importance levels are higher than or equal to Level 2. In an embodiment, the emergency transmitter message may be applied when the transmitter corresponds to the preset number or the pre-stored number, and the emergency notification message may be applied when the message includes a preset number or more of high-priority text according to the result of analysis of the message content. The voice file message may be applied to any remaining voice message. The voice file message may be a message that includes a voice file listening service. For example, the service server 120c may provide the response message in text format or may generate the response message as a voice file and provide the voice file. In an embodiment, when it is determined by using the emergency transmitter message and the emergency notification message to be overlapping, the transmission priority may be determined to be a first priority, when it is determined only by using the emergency transmitter message , the transmission priority may be determined to be a second priority, when it is determined only by using the emergency notification message, the transmission priority may be determined to be a third priority, and when it is determined only by using the voice file message, the transmission priority may be determined to be a fourth priority. Further, the voice file message may also be used for the emergency transmitter message and the emergency notification message. For example, even when it is determined only by using the emergency transmitter message, the voice file message may be applied together to provide the response message that includes the voice file. Therefore, a simplified message including phrases such as the emergency transmitter message, the emergency notification message, and the voice file message may be preferentially transmitted to the reception terminal 110 through the dedicated network according to the transmission priority. As described above, when the response message is provided through the dedicated network, the response message may not be provided to the reception terminal 110 immediately at a time point at which the outgoing call request is received in real time. For example, the service server 120c may provide a plurality of response messages corresponding to a plurality of accumulated voice messages to the reception terminal 110 at preset intervals. That is, the messages may be displayed on the reception terminal 110 in order according to the above-described transmission priority (first priority, second priority, third priority, and fourth priority) determined for the plurality of voice messages whose transmission importance levels are higher than or equal to Level 2 among the plurality of voice messages accumulated for a preset period of time (e.g., 1 day). Therefore, the receiver may receive preferentially the response messages corresponding to the messages whose transmission importance levels are high. In another embodiment, the service server 120c may further provide separate vibration notifications to the reception terminal 110 for the emergency transmitter message and the emergency notification message. For example, when the service server 120c responds to at least one of the emergency transmitter message and the emergency notification message, the service server 120c may provide the response message together with the vibration notification to make it easier for the receiver account to check the response message. In another embodiment, in the case of the emergency transmitter message corresponding to the preset number, the service server 120c may display the transmitter’s name on the reception terminal 110 so that the transmitter’s name continuously blinks for a preset period of time (e.g., 1 minute) together with the vibration notification. Further, when it is determined by using the emergency transmitter message and the emergency notification message to be overlapping, the frequency of vibration and the frequency of blinking may be increased by a preset multiple (e.g., 2 times) or more, and a red color indicating emergency may be applied to the color of the blinking light. Therefore, the efficiency of providing response messages can be improved because the response messages are provided in different ways according to the characteristics of each of the plurality of voice messages.

In another embodiment, the service server 120c may provide a risk notification message to the reception terminal 110 based on the weights that are assigned gradually in the order of the transmitter communication network, the transmitter nationality, and the result of analysis of the message content when the transmitter phone number is a spam number or is not a pre-stored number. For example, when the transmitter phone number is a spam number or is not a pre-stored number, the transmitter communication network may be a significant factor in determining risk, as it can be used to determine whether the outgoing call request is made through a domestic communication network. Even when the transmitter nationality is overseas, when the call is made via a domestic network through roaming, etc., the risk to the transmitter account may be reduced, and since the outgoing call request requested from overseas may generally be riskier, it may be desirable to check the domestic network preferentially, and thus the highest weight may be assigned to the transmitter communication network and the second highest weight may be assigned to the transmitter nationality. Further, in the result of analysis of the message content, even when the call is not from a preset number, verification may be necessary because the message may be important, when it is a spam number, the need for verification of the message content may be somewhat reduced, and even when it is a spam message, it may contain a large number of text that are determined to be of high importance, and thus a third-highest weight may be assigned to the result of analysis of the message content because its objectivity may be lowered. Therefore, the service server 120c may provide the risk notification message to the reception terminal 110 when providing a response message corresponding to a spam number or a non-pre-stored number. Therefore, the receiver may rapidly select the messages to read as they are provided with the risk notification message. In another embodiment, the service server 120c may determine whether at least one voice message received from the spam number is provided to the reception terminal 110 when it is the spam number. For example, when it is determined by using a spam number, the response message may not be provided to the reception terminal 110 in bulk, and when the voice messages are received from the same spam number more than a preset number of times (e.g., three times or more per month) within a preset period of time, the response messages corresponding to the plurality of voice messages from the same spam number may be provided to the reception terminal 110 in bulk at once at a time point at which the preset number of voice messages are received.

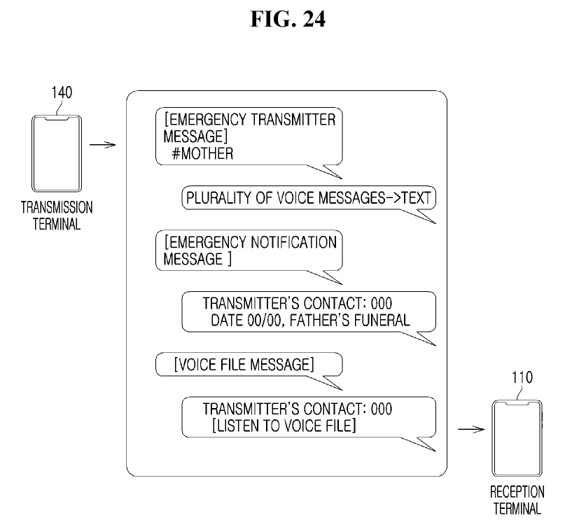

FIG. 24 is a diagram schematically illustrating examples of some of various additional notification types and message formats of the response message according to the third embodiment of the present disclosure.

Referring to FIG. 24, the service server 120c according to an embodiment may provide additional notification types indicating an emergency transmitter message, an emergency notification message, and a voice file message to the reception terminal 110 together with response messages. Further, the service server 120c may determine the format of a message as one of a summary format, a text format, and a link processing format. For example, the service server 120c may convert a plurality of voice messages into a text format to obtain a response message corresponding to each voice message. Further, the service server 120c may extract high-importance text from the plurality of voice messages and convert the extracted high-importance text into a summary format to obtain a response message corresponding to each voice message. Further, the service server 120c may generate a plurality of voice files and convert an address where a voice file corresponding to each voice message is stored into a link processing format to obtain a response message corresponding to each voice message. In an embodiment, the service server 120c may determine an additional notification type for each voice message when the transmission importance level is higher than or equal to Level 2, determine a message format corresponding to the determined additional notification type, and provide a response message to the reception terminal 110. For example, as illustrated in FIG. 24, when the additional notification type is determined to be an emergency transmitter message, the service server 120c may provide an additional notification by including the transmitter’s name together with the emergency transmitter message. Further, when the additional notification type is determined to be an emergency transmitter message, the message format may be determined to be a text format. That is, in the case of an emergency transmitter message, the content of each of the plurality of voice messages may be converted into text and the entire content may be transmitted to the reception terminal 110. Further, when the additional notification type is determined to be an emergency notification message, the message format may be determined to be a summary format. That is, in the case of the emergency transmitter message, since it is a message received from the transmitter account corresponding to a preset phone number or a pre- stored phone number, it may be desirable to allow the entire content of the message to be checked, and in the case of the emergency notification message, since it may be inefficient to transmit the entire content of the plurality of voice messages, a summarized response message may be obtained and provided to the reception terminal 110 only for items that are determined to be important categories. For example, when the additional notification type is an emergency notification message, a message format in the form of a summary format, which includes a transmitter’s contact indicating the transmitter’s name or transmitter phone number, important text that is determined to indicate a significant event, and text indicating the date and time (year, month, and day), may be applied. Further, when the additional notification type is determined to be a voice file message, the message format may be determined to be a link processing format. That is, in the case of a voice file message, a message format in the form of a link processing format, which includes the transmitter’s contact indicating the transmitter’s name or transmitter phone number, and a link to an address where the voice file of each of the plurality of voice messages is stored (which may correspond to [Listen to Voice File] in FIG. 24), may be applied. That is, when the transmission importance level is higher than or equal to Level 2, the service server 120c may determine an additional notification type for each of the plurality of voice messages, determine a message format corresponding to the determined additional notification type, and provide a response message to the reception terminal 110. In another embodiment, when the transmission importance level is lower than Level 1, the service server 120c may provide a response message to the reception terminal 110 according to a message format in which a different summary format is applied to each voice message based on the transmitter account characteristic information. For example, the case in which the transmission importance level is lower than Level 1 may correspond to a message of somewhat lower importance. When the transmitter phone number is a spam number, a response message summarized in the order of a separate notification message indicating that the message is expected to be spam (e.g., “spam expected message”) and the categories (e.g., finance, insurance, etc.) corresponding to the plurality of voice messages may be provided. Further, when the transmitter phone number is not a spam number, the transmitter nationality is overseas, and an overseas line is used as the transmitter communication network, a response message summarized in the order of the location of the transmitter nationality and the categories corresponding to the plurality of voice messages may be provided. Further, when the transmitter phone number is not a spam number, the transmitter nationality is overseas, and a domestic line is used as the transmitter communication network, a response message summarized in the order of the location of the transmitter nationality, the transmitter contact information indicating the transmitter’s name or transmitter phone number, the categories corresponding to the plurality of voice messages, and an array of a plurality of pieces of important text may be provided. Further, when the transmitter phone number is not a spam number, the transmitter nationality is domestic, and a domestic line is used as the transmitter communication network, a response message summarized in the order of the transmitter contact information and the array of a plurality of pieces of important text may be provided. Therefore, the efficiency of providing the response message according to transmitter account authentication can be improved because in that the receiver may receive the summarized response message in a different manner according to the characteristics of each of a plurality of transmitter accounts.

According to an embodiment, user satisfaction can be improved by reducing the burden of large roaming charges that may arise during long-term stays abroad. Further, the efficiency of response message provision can be improved by identifying outgoing call requests received from unnecessary transmitter accounts and providing response messages, and the satisfaction of users receiving response messages can be improved by providing voice messages with different call processing methods applied according to transmitter account characteristic information.

Various embodiments of the present disclosure may be implemented as software including one or more instructions stored in a storage medium (e.g., a memory) that can be read by a machine (e.g., a display device or a computer). For example, a processor 102 of the machine may call at least one of the stored instructions from the storage medium and execute the instructions. This enables the device to operate to perform at least one function in accordance with the at least one called instruction. The one or more instructions may include code generated by a compiler or code executable by an interpreter. The storage medium readable by the device may be provided in the form of a non-transitory storage medium. Here, the term “non-transitory” means only that the storage medium is a tangible device and does not contain signals (e.g., electromagnetic waves), and this term does not distinguish between a case where data is stored semi-permanently and a case where data is stored temporarily in the storage medium.

According to one embodiment, the method according to various embodiments disclosed in the present disclosure may be included in a computer program product and provided. The computer program product may be traded between a seller and a buyer as a commodity. The computer program product may be distributed in the form of a machine-readable storage medium (e.g., a compact disc read-only memory (CD-ROM)), or may be distributed online (e.g., by download or upload) through an application store (e.g., Play Store TM) or directly between two user devices (e.g., smartphones). In the case of online distribution, at least a portion of the computer program product may be temporarily stored or temporarily generated in a machine-readable storage medium, such as a memory of a manufacturer’s server, an application store’s server, or an intermediary server.

While the present disclosure has been described with reference to the accompanying drawings, it is not limited to the disclosed embodiments and drawings, and it will be understood by those skilled in the art that various changes in form and details may be made without departing from the spirit and scope of the present disclosure. Therefore, the disclosed methods should be considered from an exemplary point of view for description rather than a limiting point of view. Even when the embodiments are described and the effects according to the configuration of the present disclosure are not explicitly described, effects that may be predicted by the configuration may also be recognized. The scope of the present disclosure is defined not by the detailed description of the present disclosure but by the appended claims and encompasses all modifications and equivalents that fall within the scope of the appended claims and will be construed as being included in the present disclosure.

What is claimed is:

1. A method of providing a response message in response to a message transmission request, the method comprising:
receiving, by a telecommunications company server, from a transmission terminal, an outgoing call request for transmitting a plurality of voice messages to a reception terminal;
determining, by the telecommunications company server, whether a receiver account corresponding to the reception terminal is subscribed to an overseas notification service upon receiving the outgoing call request;
routing, by the telecommunications company server, a line connection between the reception terminal and the transmission terminal to pass through a service server when the receiver account is subscribed to the overseas notification service;
providing, by the service server, a first response message corresponding to a first voice message, which is any one of the plurality of voice messages, to the transmission terminal; and
providing, by the service server, a second response message corresponding to a second voice message, which is any one of the plurality of voice messages, to the reception terminal.

2. The method of claim 1, further comprising determining, by the service server, each of the plurality of voice messages as the first voice message or the second voice message based on results of analysis of the plurality of voice messages.

3. The method of claim 2, wherein the determining of each of the plurality of voice messages as the first voice message or the second voice message includes:
determining, by the service server, a level of need for transmission indicating a degree to which the plurality of voice messages need to be transmitted to the receiver account; and
determining, by the service server, each of the plurality of voice messages as the first voice message or the second voice message according to the level of need for transmission.

4. The method of claim 1, wherein, in the determining whether the receiver account is subscribed to the overseas notification service, when a location of the reception terminal is determined to be overseas, the telecommunications company server determines whether the receiver account is subscribed to the overseas notification service.

5. The method of claim 1, wherein, in the providing, by the service server, the first response message to the transmission terminal, the first response message is provided to the transmission terminal using a domestic line, and
in the providing, by the service server, the second response message to the reception terminal, the second response message is provided to the reception terminal using an overseas line.

6. The method of claim 1, wherein, in the providing of the second response message to the reception terminal, the service server provides the second response message to the reception terminal using an overseas public network.

7. The method of claim 4, wherein the determining whether the receiver account is subscribed to the overseas notification service further includes:
determining, by the telecommunications company server, whether the receiver account is subscribed to the overseas notification service based on a first universal subscriber identity module (USIM) for domestic use that is installed in the reception terminal when the location of the reception terminal is determined to be overseas;
performing, by the service server, an identity authentication request on the reception terminal when the receiver account is subscribed to the overseas notification service; and
requesting, by the service server, registration of at least one piece of overseas notification authentication information from the reception terminal when the identity authentication is completed.

8. The method of claim 7, further comprising performing, by the service server, authentication on the reception terminal based on the registered overseas notification authentication information when a second USIM for overseas use is installed in the reception terminal.

9. The method of claim 8, further comprising requesting, by the service server, installation of the first USIM from the reception terminal when a preset period of time has elapsed since the second USIM was installed.

10. A system for providing a response message in response to a message transmission request, the system comprising:
a telecommunications company server configured to receive, from a transmission terminal, an outgoing call request for transmitting a plurality of voice messages to a reception terminal, determine whether a receiver account corresponding to the reception terminal is subscribed to an overseas notification service, upon receiving the outgoing call request, and route a line connection between the reception terminal and the transmission terminal to pass through a service server when the receiver account is subscribed to the overseas notification service; and
the service server configured to provide a first response message corresponding to a first voice message, which is any one of the plurality of voice messages, to the transmission terminal and provide a second response message corresponding to a second voice message, which is any one of the plurality of voice messages, to the reception terminal.

11. The system of claim 10, wherein the service server determines each of the plurality of voice messages as the first voice message or the second voice message based on results of analysis of the plurality of voice messages.

12. The system of claim 11, wherein the service server determines a level of need for transmission indicating a degree to which the plurality of voice messages need to be transmitted to the receiver account, and determines each of the plurality of voice messages as the first response message or the second response message according to the level of need for transmission.

13. A computer-readable recording medium on which a program for executing the method of claim 1 on a computer is recorded.

14. The method of claim 1, further comprising:
receiving, by a service server, a service provision request for requesting provision of an overseas notification service from a receiver account corresponding to a reception terminal;
determining, by the service server, whether the receiver account is subscribed to the overseas notification service upon receiving the service provision request;
performing, by the service server, first identity authentication on the receiver account using an ID and a password when the receiver account is subscribed to the overseas notification service;
performing, by the service server, second identity authentication on the receiver account using at least one of a pre-designated keyword, an access Internet Protocol (IP) band, location information, and an email address when the first identity authentication is performed normally;
determining, by the service server, whether a timeout occurs based on a time count situation in which a count starts according to a type of universal subscriber identity module (USIM) inserted into the reception terminal when the second identity authentication is performed; and
providing, by the service server, a message indicating that the overseas notification service is provided to the receiver account when the timeout does not occur.

15. The method of claim 1, further comprising:
obtaining, by the service server, transmitter account characteristic information including at least one of a transmitter nationality, a transmitter communication network, and a transmitter phone number for a transmitter account corresponding to the transmission terminal;
determining, by the service server, a call processing method including at least one of an additional notification type, a transmission priority, a type of network used for transmission, and a format of a message to be transmitted for the plurality of voice messages based on the transmitter account characteristic information; and
providing, by the service server, response messages corresponding to the plurality of voice messages to the reception terminal based on the call processing method.
